(19) United States
(12) Patent Application Publication
(10) Pub. No.: US 2026/0292114 A1
(43) Pub. Date: Sep. 24, 2026

(54) PHOTOREALISTIC 4D VIDEO DIFFUSION MODEL

(71) Applicant: Snap Inc., Santa Monica, CA (US)

(72) Inventors: Hsin-Ying Lee, San Jose, CA (US); Willi Menapace, Los Angeles, CA (US); Tuan Duc Ngo, Santa Monica, CA (US); Aliaksandr Siarohin, Santa Monica, CA (US); Ivan Skorokhodov, Santa Monica, CA (US); Sergey Tulyakov, Santa Monica, CA (US); Mikhail Vasilkovskii, Playa Vista, CA (US); Chaoyang Wang, Los Angeles, CA (US); Peter Wonka, Thuwal (SA); Peiye Zhuang, Culver City, CA (US)

(21) Appl. No.: 19/088,463

(22) Filed: Mar. 24, 2025

(51) Int. Cl. H04N 13/117; G06T 7/70; H04N 13/167

(52) U.S. Cl. CPC H04N 13/117; G06T 7/70; H04N 13/167

(57) ABSTRACT

Examples relate to computer-implemented systems and methods for generating four-dimensional (4D) video content. A 4D video generation model receives a freeze-time video showing a scene varying in viewpoint and a fixed-view video showing the scene varying in time. The model processes these inputs through parallel pathways—a freeze-time pathway and a fixed-view pathway—each comprising pretrained diffusion transformer blocks. The pathways are synchronized via interleaved synchronization layers to generate a grid of video frames varying consistently in both time and viewpoint. The generated frame grid can be used to reconstruct a three-dimensional representation of the scene for real-time rendering of views from arbitrary viewpoints.

### TECHNICAL FIELD

The present disclosures relate to computer vision and machine learning technologies and, in some examples, to algorithms and systems to generate spatially and temporally consistent four-dimensional video content using synchronized parallel token streams in a modified video diffusion transformer model.

### BACKGROUND

Artificial Intelligence (AI) has made significant strides in recent years, particularly in the domains of computer vision and natural language processing. Machine learning techniques, such as deep learning and neural networks, have enabled AI systems to process and generate complex visual and textual data with increasing sophistication. In the realm of video generation, diffusion models can be used to create high-quality, diverse content from text or image inputs. These models work by gradually denoising random noise to produce coherent video frames, guided by the input prompt. Transformer architectures, originally developed for natural language tasks, have been adapted for video generation, potentially offering improved quality, scalability, and/or training efficiency.

Extended Reality (XR) technologies, encompassing Virtual Reality (VR), Augmented Reality (AR), and Mixed Reality (MR), provide immersive and interactive experiences. These technologies rely on 3D rendering techniques to create convincing virtual environments or overlay virtual content onto the real world. The development of lightweight, high-resolution displays and advanced motion tracking systems has the potential to further improve user experience in XR applications.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. Some non-limiting examples are illustrated in the figures of the accompanying drawings in which:

FIG. 1 is a schematic diagram of a 4D scene generation system for generating views of a scene, according to some examples.

FIG. 2 is a flowchart showing operations of a method for generating views of a scene, according to some examples.

FIG. 3 is a schematic diagram showing generation of a 3D representation of a scene, according to some examples.

FIG. 4 is a schematic diagram illustrating the architecture of a 4D video generation model with parallel pathways for processing fixed-view and freeze-time videos using diffusion blocks, according to some examples.

FIG. 5 is a schematic diagram illustrating a 4D generation block with freeze-time and fixed-view frozen DIT blocks connected by a synchronization layer, according to some examples.

FIG. 6 is a flowchart showing operations of a method for generating 4D video content using parallel freeze-time and fixed-view pathways with synchronized diffusion blocks, according to some examples.

FIG. 7 is a flowchart showing operations of a method for training a 4D video generation model using synchronized parallel pathways for processing video frames varying in viewpoint and time, according to some examples.

FIG. 8 is a perspective view of a head-worn device, in accordance with some examples.

FIG. 9 illustrates a further view of the head-worn device of FIG. 8, in accordance with some examples.

FIG. 10 illustrates a perspective view of a projector and waveguide, showing light propagated toward an eye, in accordance with some examples.

FIG. 11 is a diagrammatic representation of a networked environment in which the present disclosure may be deployed, according to some examples.

FIG. 12 is a diagrammatic representation of a digital interaction system that has both client-side and server-side functionality, according to some examples.

FIG. 13 illustrates a system including a head-wearable apparatus, according to some examples.

FIG. 14 is a diagrammatic representation of a machine in the form of a computer system within which a set of instructions may be executed to cause the machine to perform any one or more of the methodologies discussed herein, in accordance with some examples.

FIG. 15 is a block diagram showing a software architecture within which examples may be implemented, in accordance with some examples.

### DETAILED DESCRIPTION

The examples described herein relate to systems and methods for generating four-dimensional (4D) video content with synchronized temporal and spatial consistency. These technologies address challenges in creating immersive extended reality (XR) experiences that require both realistic motion and viewpoint flexibility.

A 4D scene generation system processes input data to create photorealistic video content that can be viewed from multiple angles while maintaining temporal coherence. The system includes a 4D video generation model that receives inputs in the form of a fixed-view video showing scene motion from one perspective and a freeze-time video showing a static scene from different viewpoints. The 4D video generation model generates a set of video frames that vary in time and in viewpoint, which can be conceptualized as a 2D grid of video frames in which the vertical axis denotes varying viewpoint and the horizontal axis denotes varying time, such that columns of the array constitute freeze-time videos and rows of the array constitute fixed-view videos. It will be appreciated that this arrangement of video frames in the output of the 4D video generation model can be varied in different examples, but a 2D grid of frames with y=viewpoint and x=time will be used as a convention herein for simplicity of reference.

The 4D video generation model employs a novel two-stream or two-pathway architecture to process the fixed-view video and freeze-time video inputs. One pathway handles temporal updates along rows of video frames sharing the same viewpoint, while the other pathway processes spatial updates along columns of frames sharing the same timestamp. This parallel processing approach utilizes pre-trained diffusion transformer (DiT) blocks arranged in the two pathways—a freeze-time pathway and a fixed-view pathway.

The architecture also includes a synchronization mechanism between the two processing pathways. After each DiT block processes its respective frames, a synchronization layer exchanges information between the temporal and spatial token pathways to maintain consistency. In different examples, the system implements either “hard” synchronization, which strictly enforces consistency by averaging token updates, or “soft” synchronization, which allows more flexible adaptive updates based on the current diffusion timestep.

The model generates a grid of video frames where each row represents a fixed-view video sequence and each column represents a freeze-time sequence from different viewpoints. This grid structure enables the creation of coherent 4D video content that can be viewed from arbitrary angles while maintaining smooth motion.

In some examples, the 4D video generation model is trained using two complementary data sources. First, regular videos are processed with simulated camera motion through 2D transformations to train the model to learn basic temporal-spatial relationships. Second, a smaller dataset of true multi-view animated 3D objects is used for fine-tuning the model to refine its understanding of 3D consistency.

The output of the 4D video generation model can be used to construct a 3D Gaussian splat (3DGS) representation or other 3D representation of the scene, potentially associated with temporal information to encode time-varying action in the scene. This 3D representation enables real-time rendering of novel viewpoints for XR applications. When integrated with an XR device, the system can receive pose data, generate appropriate point-of-view transformations, and display photorealistic views of the scene from the user's current perspective.

In some examples, the processing pipeline incorporating the 4D video generation model operates efficiently compared to existing approaches. For an 8×8 grid of frames at 288×512 resolution, some example systems can generate output in approximately one minute, compared to hours required by existing approaches. The model can also generate longer 4D video sequences through autoregressive generation, advancing along time and/or viewpoint axes in a sliding window fashion.

Applications of these techniques extend beyond entertainment and gaming. The system can process both synthetic and real-world scenes, enabling creation of immersive experiences from captured footage. The ability to generate consistent multi-view video content has potential uses in virtual production, architectural visualization, and interactive training simulations.

The described examples overcome several technical challenges in 4D content generation. By leveraging pre-trained video diffusion models and implementing novel synchronization mechanisms, the system achieves both computational efficiency and high-quality output. The parallel processing architecture maintains temporal and spatial consistency while avoiding the distributional shifts and artifacts that can occur with sequential approaches.

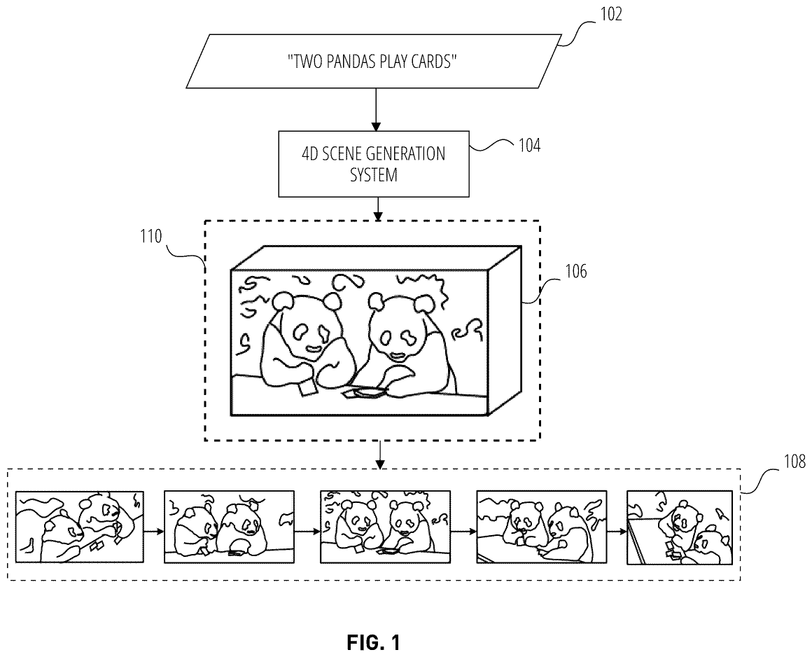

FIG. 1 is a schematic diagram of a 4D scene generation system 104 for generating views of a scene. The 4D scene generation system 104 receives an input 102, which may be a text input (e.g., the text “two pandas play cards” as shown in the illustrated example), an image input, or another input suitable for being processed by a diffusion model or transformer model to generate a video based on the input 102. The input 102 is processed by a 4D scene generation system 104, which utilizes various components to create a 4D scene model 110 representative of a scene generated based on the input 102. The 4D scene model 110 is capable of generating multiple views of the scene from different points of view and/or at different points in time. In some examples, the scene includes an action taking place over time, such as one or more objects moving or undergoing other visual changes. In some examples, the views of the scene can be photorealistic. In some examples, the views of the scene can include views of an environment in which the action takes place, such as a detailed background, one or more potentially occluding objects, and/or one or more 3D objects that change appearance when viewed from different points of view.

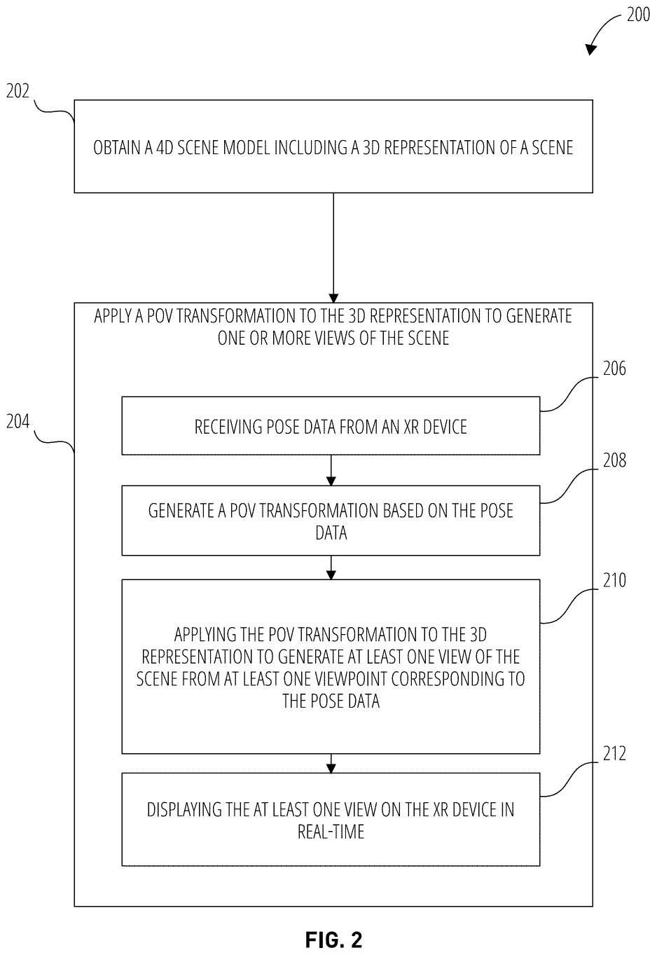

The 4D scene generation system 104 can be used to generate outputs. One of these outputs can be a 3D representation of the scene, shown as a canonical 3D Gaussian Splats (3DGS) representation 106. This 3D representation can be used by other software modules or other devices to perform different tasks related to the generated scene, such as XR-related tasks. These tasks can include displaying interactive views of the scene, showing different points of view of the scene at different points in time, modeling collision of virtual objects with elements of the scene, and so on. Examples of interactive XR tasks using the outputs of the 4D scene model 110 are described below with reference to method 200 of FIG. 2.

The 4D scene model 110 can also generate rendered videos of the scene, such as output video 108, showing the action of the scene over a period of time and/or from multiple points of view. In this example, the output video 108 shows two pandas playing cards at a table while the point of view (also referred to herein as the camera or the camera position, meaning the position of a hypothetical video camera that would be used to shoot a real-world version of the video) pans in a circular motion around them.

The 4D scene model 110 includes the 3DGS representation 106 and may also include temporal information (not shown) used in generating outputs. The 3DGS representation 106 serves as a foundation for the 4D scene, representing a static view of the 3D scene at a fixed point in time during the action, also referred to as a canonical frame. The 3DGS representation 106 can be spatially transformed to generate a view of the static scene from an arbitrary point of view (POV). The temporal information captures the dynamic aspects of the scene, and can be applied to the 3DGS representation 106 to generate views of the scene shifted in time from the canonical frame. The temporal information represents how the scene changes over time, enabling the 4D scene model 110 to capture and reproduce dynamic interactions and motions within the scene.

Thus, the 4D scene model 110 can provide a complete 4D representation of the scene, including both static and dynamic elements as seen at multiple points in time and from multiple points of view. In some examples, the first stages of the 4D scene generation system 104 can be provided as a developer tool to software developers, artists, or content creators to enable them to create 4D scene models 110. The latter stages of the 4D scene generation system 104, including one or more 4D scene models 110 generated previously, can be provided to end users (such as end users of an XR device) to present the users with views of 4D scenes, such as interactive XR views of scenes.

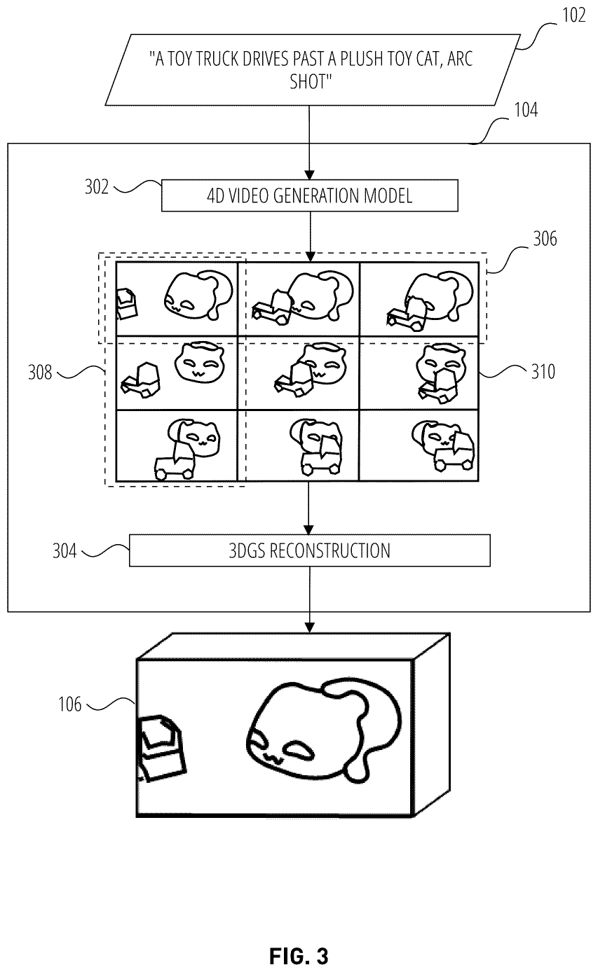

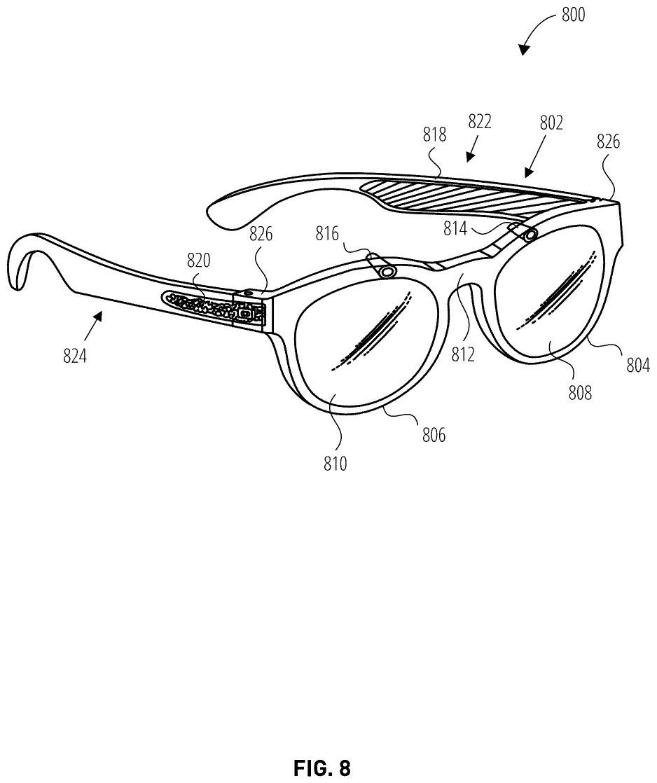

The 4D scene generation system 104 can thus be used to generate 4D scenes from inputs, such as text or image inputs. Details of how the 4D scene generation system 104 generates the 4D scene model 110, and how the 4D scene model 110 generates outputs, are addressed in further detail in reference to FIG. 3 through FIG. 2 below. FIG. 8 through FIG. 15 show examples of devices, systems, and software architectures that can be used to operate the 4D scene generation system 104 to generate 4D scene models 110 and/or to use the 4D scene generation system 104 to perform various tasks using the outputs of 4D scene models 110.

FIG. 2 illustrates an example method 200 for generating views of a scene. Whereas the method 200 is described in reference to the 4D scene generation system 104 described above, it will be appreciated that some examples can be performed by other suitable systems, devices, or components.

Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some examples, the method 200 includes obtaining a 4D scene model 110 at operation 202. The 4D scene model 110 includes a 3D representation of a scene (such as 3DGS representation 106) and a set of temporal data. In some examples, operation 202 includes obtaining a 4D scene model 110 generated in accordance with techniques described herein, such as a 4D video generation model 302 and/or method 600 described below with reference to FIG. 3 through FIG. 6. However, it will be appreciated that other 4D scene models, trained or otherwise generated in accordance with different techniques, can be used to perform method 200 in some examples. In some examples, the components of the 4D scene model, such as the 3D representation and temporal data, are generated based on a reference video showing the action occurring in the scene, using techniques as described in reference to the example 4D scene generation system 104 or using other techniques for deriving 3D scene information and temporal data from video input.

According to some examples, the method 200 includes applying at least one point of view (POV) transformation to the 3D representation to generate one or more views of the scene at operation 204. The 3DGS representation 106 can be processed to generate one or more views of the scene, such as video frames showing the action within the scene at a specific point in time, seen from a particular POV. The temporal data can be applied to the 3DGS representation 106 to generate views of the scene at arbitrary points in time from arbitrary points of view, using the known Gaussian splat deformation techniques. In some examples, different types of 3D representations can be used, and the various temporal and/or per-frame deformations can be applied to the different 3D representation to generate views of the scene.

In some examples, operation 204 includes one or more of operation 206 through operation 212.

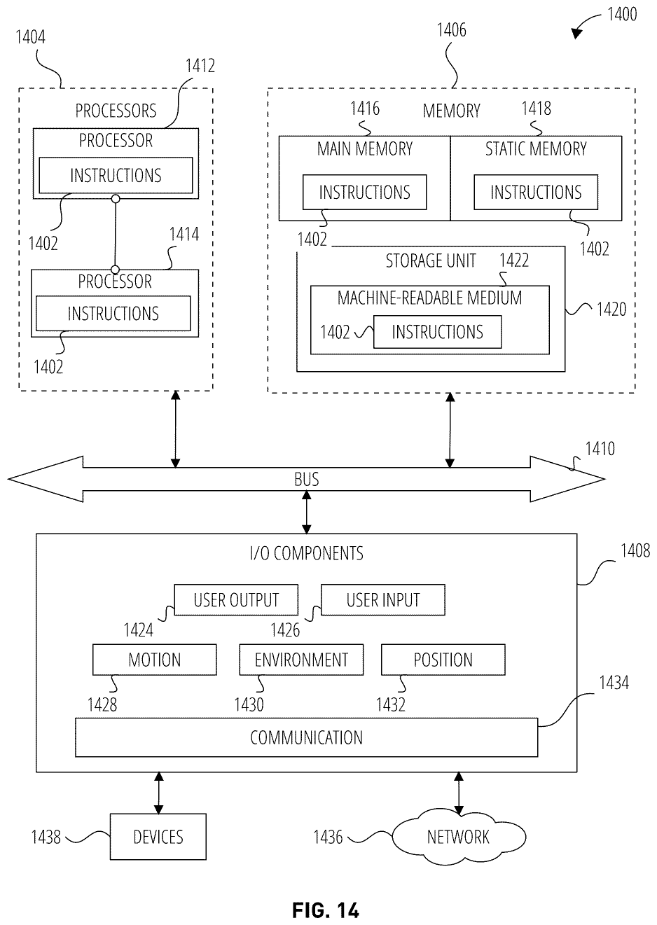

According to some examples, operation 204 includes receiving pose data from an XR device at operation 206. Examples of XR devices and systems are described below with reference to FIG. 8 through FIG. 15. Some XR devices or systems include position components 1432, motion components 1428, and/or environmental components 1430 (see FIG. 14) for determining a pose of the XR device. For example, an inertial measurement unit (IMU) or other position sensor can be used by a head-mounted or hand-held XR device to continuously determine the orientation and location of one or more cameras of the XR device. This orientation and location information is referred to herein as pose data. The pose data can be generated (e.g., by the position components 1432 of an XR device) and provided to the 4D scene generation system 104.

According to some examples, operation 204 includes selecting or generating at least one POV transformation based on the pose data at operation 208. In some examples, a pose data processing module can determine a POV transformation (e.g., translation and/or rotation in any of one to three dimensions or axes) of the pose corresponding to the pose data from a canonical pose of the 3DGS representation 106. For example, the pose data processing module can process the pose data continuously or periodically (e.g., at 30 frames per second or another suitable rate) to update a POV of the XR device relative to a scene that has already been presented at a given POV.

According to some examples, operation 204 includes applying the selected or generated POV transformation to the 3D representation to generate at least one view of the scene from at least one viewpoint corresponding to the pose data at operation 210. In some examples, once the POV transformation has been selected or generated, the 4D scene generation system 104 renders a new view of the scene (e.g., a video frame) from the updated POV corresponding to the pose data (e.g., the pose of the XR device) by applying the POV transformation to the 3DGS representation 106. In some examples, the rendering of the updated view of the scene also includes applying temporal data, stored as part of the 4D scene model 110, based on time elapsed since the last update, such that the view rendered for the XR device shows the action in the scene occurring over time while the POV of the XR device changes to provide a changed POV on the scene.

According to some examples, operation 204 includes displaying the at least one view on the XR device in real-time at operation 212. The rendered updated view can be displayed on a display of the XR device (such as one of the displays of the display system 800 of FIG. 8). In some examples, operation 204, including operation 206 through operation 212, can be performed for each display of a binocular display, such as the display system 800 of FIG. 8, in order to render two different points of view of the scene for two displays, and thereby providing a stereoscopic view of the scene that enhances the realism of the 3D appearance of the scene.

It will be appreciated that some examples may use the 4D scene model 110 differently to achieve different effects. The 4D scene model 110 can be used to generate stereoscopic or monoscopic videos of a scene. The 4D scene model 110 can be used to generate multiple views of the scene from different points of view. The 4D scene model 110 can be used to generate views of the scene that can be navigated temporally by a user, to jump or traverse forward in backward in time to view different portions of the action being performed. The 4D scene model 110 can be used to generate dynamic 3D effects that can be applied to other content, such as 3D animations applied to a real-world scene or object viewed through an XR display. It will be appreciated that there are many other potential applications of the 4D scene model 110 for generating and applying 4D scene information to generate different interactive or non-interactive spatial and temporal views of a scene.

FIG. 3 is a schematic diagram showing generation of a 3D representation of a scene using a 4D video generation model 302 and 3DGS reconstruction component 304.

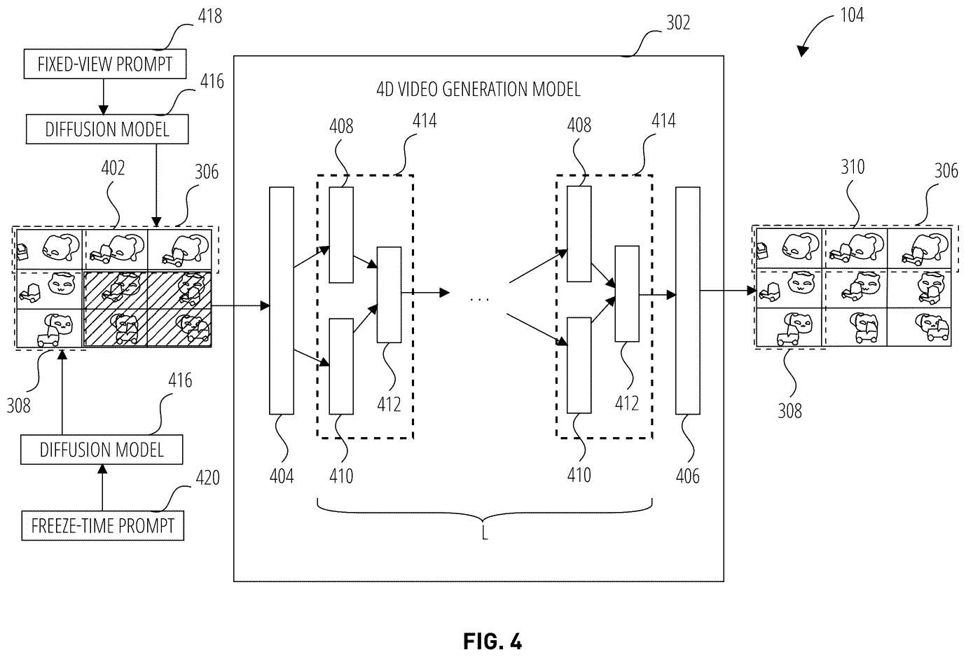

The system receives an input 102 providing information about a scene. In the illustrated example, the input 102 is a text input describing a scene, such as “A TOY TRUCK DRIVES PAST A PLUSH TOY CAT, ARC SHOT”. In some examples, the input 102 can be an image or a video showing a scene. The input 102 is preprocessed by the 4D scene generation system 104 before the preprocessed data is provided to a 4D video generation model 302. Example preprocessing techniques are described below with reference to FIG. 4. In some examples, the preprocessing of the input 102 generates a fixed-view video and a freeze-time video of the described or depicted scene.

The 4D video generation model 302 processes the preprocessed data (e.g., the fixed-view video and freeze-time video) to generate a 2D array or grid of video frames, shown as video frame array 310, organized with time varying along one axis (in this example, the vertical axis) and viewpoint varying along another axis (in this example, the horizontal axis). The 2D array includes the input fixed-view video 306 showing temporal changes from a single viewpoint, and the input freeze-time video 308 showing viewpoint changes at a fixed time. The video frame array 310 thus combines both temporal and viewpoint variations. It will be appreciated that, whereas the video frame array 310 is shown as a small 3×3 video frame array for visibility, some examples generate larger arrays, such as 8×8 or larger dimensions.

The generated video frame array 310 is provided to a 3DGS reconstruction component 304. The 3DGS reconstruction component 304 processes the video frame array 310 to generate a three-dimensional Gaussian splat (3DGS) representation 106 of the scene.

In some examples, the 3DGS reconstruction component 304 employs a dense tracking technique to establish correspondences between pixels across different viewpoints and timestamps in the frame grid. This enables initialization of Gaussian splat positions and motions in canonical space. The module may then fine-tune the Gaussian splat shapes and opacities using photometric loss to enhance visual quality. Dense tracking 3DGS reconstruction is described by Ngo, Tuan Duc, et al. “DELTA: Dense Efficient Long-range 3D Tracking for any video.” arXiv preprint arXiv:2410.24211 (2024) (hereinafter “DELTA”), which is hereby incorporated by reference in its entirety.

In some examples, the 3DGS reconstruction component 304 applies the DELTA dense tracking technique to each column and row of the video frame array 310 independently. For each column, the dense tracking establishes 3D correspondences between pixels across different viewpoints at a fixed timestamp. Similarly, for each row, it establishes 3D correspondences between pixels across different timestamps at a fixed viewpoint. In some examples, a trained dense tracking neural network can be used to process a video sequence and output per-pixel 3D motion predictions within seconds.

The correspondences from dense tracking enable direct initialization of Gaussian splat positions and motions in canonical space. By aggregating the tracked point clouds from all columns, the 3DGS reconstruction component 304 obtains an initial estimate of the static scene geometry. The temporal correspondences from row-wise tracking then provide initialization for how each Gaussian splat moves over time. This initialization approach eliminates the need for lengthy optimization to determine initial splat configurations.

After initialization, the 3DGS reconstruction component 304 performs a fine-tuning phase using photometric loss to refine the Gaussian splat properties. The fine-tuning optimizes splat shapes, opacities, and positions to improve visual quality while maintaining the initialized motion trajectories. This approach significantly reduces reconstruction time compared to previous optimization-based methods, requiring only about 10 minutes of additional processing after the 2-minute frame grid generation to produce the final time-varying 3DGS representation 106, including both the 3DGS data and temporal data.

The 3DGS representation 106 provides a complete four-dimensional model of the scene that captures both spatial structure and temporal dynamics. This representation enables real-time rendering of novel viewpoints of the animated scene.

FIG. 4 is a schematic diagram illustrating the architecture of a 4D video generation model 302 with parallel pathways for processing fixed-view and freeze-time videos using diffusion blocks.

The 4D video generation model 302 receives input from a fixed-view prompt 418 and a freeze-time prompt 420. The fixed-view prompt 418 and freeze-time prompt 420 can be generated from various sources, and can be of various formats, including text, image, or video. In some examples, the input 102 received by the 4D scene generation system 104 (shown in FIG. 1) is processed to separate the information about the scene into temporal and viewpoint information. For example, the textual input 102 shown in FIG. 1 can be processed by a natural language categorization model to generate the fixed-view prompt 418 to encode the temporal information about the scene (e.g., “a toy truck drives past a plush toy cat”) and to generate the freeze-time prompt 420 to encode the viewpoint information about the scene (e.g., “arc shot of a toy truck and a plush toy cat”). In some examples, multiple types of input data can be combined to generate the fixed-view prompt 418 and freeze-time prompt 420: for example, a single image of the plush toy cat and the toy truck can be combined with textual information indicating time and/or viewpoint variation, such that the fixed-view prompt 418 combines the image data with the temporal data (e.g., “the toy truck drives past”), and the freeze-time prompt 420 combines the image data with the viewpoint data (e.g., arc shot”). In some examples, the input 102 includes a video, which is analyzed by a video transformer model to extract temporal and viewpoint data, which are then included in the fixed-view prompt 418 and freeze-time prompt 420, respectively, along with all or part of the video data.

The fixed-view prompt 418 and freeze-time prompt 420 are processed by respective diffusion models 416 to generate a fixed-view video 306 and a freeze-time video 308. The fixed-view video 306 and freeze-time video 308 show views of the same scene, with the frames of the fixed-view video 306 varying in time, and the frames of the freeze-time video 308 varying in viewpoint. Depending on the format of the fixed-view prompt 418 and freeze-time prompt 420, these diffusion models 416 are trained to generate video from some combination of text, image, video, and/or other types of data. In some examples, different transformer model types or different video generative model types can be used in place of diffusion models.

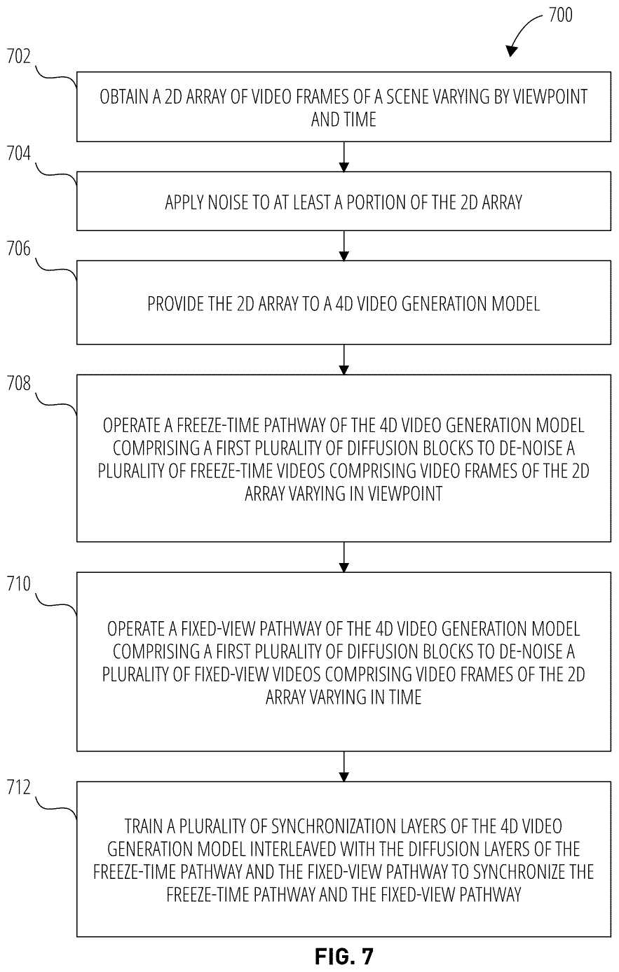

During training, the 4D video generation model 302 receives a noised video frame array 402 as input. The noised video frame array 402 is generated using techniques described in greater detail below with reference to the training method 700 of FIG. 7. The 4D video generation model 302 is trained to de-noise the noised video frame array 402 inputs to generate de-noised video frame array 310 outputs, as shown in FIG. 4, according to the method 700 of FIG. 7.

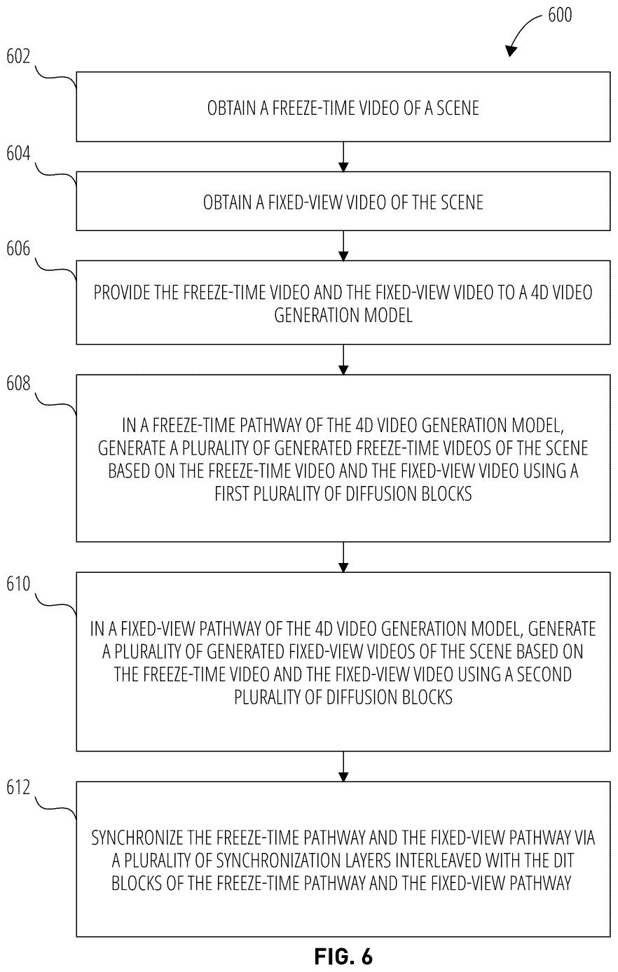

During inference, the trained 4D video generation model 302 can receive the fixed-view video 306 and freeze-time video 308 as inputs and generate the video frame array 310 as its output. Inference can be performed in accordance with the 4D video generation method 600 of FIG. 6, described below.

The 4D video generation model 302 includes an input layer 404 that receives the generated fixed-view video 306 and freeze-time video 308 as inputs during inference, or the noised video frame array 402 as input during training. The input layer 404 processes the inputs, decomposed into video tokens, through parallel pathways passing through multiple 4D generation blocks 414 arranged in series. Each 4D generation block 414 contains freeze-time frozen DiT blocks 408 and fixed-view frozen DiT blocks 410 arranged in parallel. The token outputs of the freeze-time frozen DiT block 408 and fixed-view frozen DiT block 410 of each 4D generation block 414 are then synchronized by a synchronization layer 412 of the 4D generation block 414 to generate synchronized token outputs to be processed by the next 4D generation block 414 in the series (or, in the case of the final 4D generation block 414, by an output layer 406 of the 4D video generation model 302).

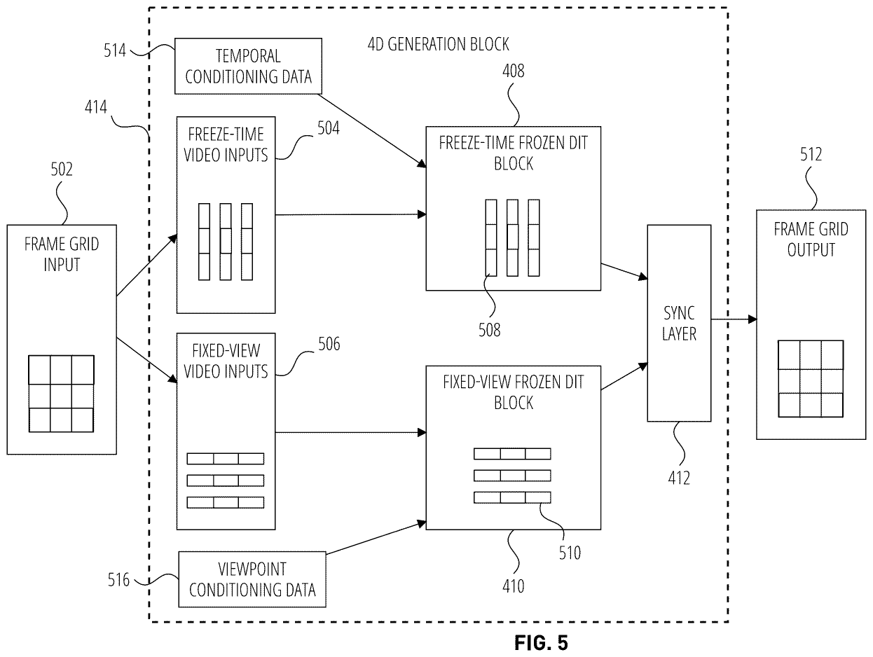

The freeze-time frozen DiT blocks 408 process sequences of video frames showing the scene varying in viewpoint, while the fixed-view frozen DiT blocks 410 process sequences showing the scene varying in time. The DiT blocks comprise pretrained weights from an existing video diffusion model that are frozen during training. The freeze-time frozen DiT block 408 and fixed-view frozen DiT block 410 are described in greater detail with reference to FIG. 5 below.

Synchronization layers 412 are interleaved between the DiT blocks of both pathways. The synchronization layers 412 exchange information between the two parallel token pathways to maintain consistency between the temporal and viewpoint variations. The synchronized token outputs are provided to subsequent 4D generation blocks 414 or to an output layer 406.

The output layer 406 generates a video frame array 310 combining both temporal and viewpoint variations, based on the synchronized token outputs received from the final 4D generation block 414 in the series. The video frame array 310 organizes the generated frames with time varying along one axis and viewpoint varying along another axis. In some examples, the array dimensions may be 8×8 video frames, or may be larger.

The illustrated example includes a number L of 4D generation blocks 414, corresponding to a pretrained video diffusion model having L DiT blocks used to provide the weights for the freeze-time frozen DiT blocks 408 and fixed-view frozen DiT blocks 410.

In some examples, the dimensions of the video frame array 310 are enlarged in the time and/or viewpoint dimensions through autoregressive generation. For example, the video frame array 310 can be enlarged through sliding window autoregressive generation along both the time and viewpoint axes. For the time axis, the 4D video generation model 302 can be trained to process a window of frames from the fixed-view video 306 to predict subsequent temporal frames while maintaining the same viewpoint. Similarly for the view axis, the 4D video generation model 302 can be trained to process a window of frames from the freeze-time video 308 to predict additional viewpoints while maintaining the same timestamp. The sliding window approach enables generation beyond the initial video frame array 310 dimensions (e.g., 8×8 video frames) by progressively synthesizing new frames based on previously generated ones. The model maintains temporal and viewpoint consistency through the synchronized parallel pathways even during autoregressive generation, with the synchronization layers 412 coordinating information exchange between the time-varying and view-varying frame sequences. The autoregressive generation can extend the frame array 310 to arbitrary dimensions while preserving the spatiotemporal coherence established by the model's two-stream architecture.

The architecture of the 4D video generation model 302 shown in FIG. 3 can enable efficient generation of spatially and temporally consistent 4D video content by leveraging pretrained video diffusion model weights while training only the synchronization layers, as described in greater detail below with reference to FIG. 7. This approach can reduce training data requirements while maintaining high visual quality and resulting in an efficient inference process.

FIG. 5 is a schematic diagram illustrating a 4D generation block 414 of the 4D video generation model 302 with a freeze-time frozen DiT block 408 and fixed-view frozen DiT block 410 generating video token outputs synchronized by a synchronization layer 412.

The 4D generation block 414 receives a frame grid input 502 comprising video tokens corresponding to a two-dimensional array of video frames varying in time (horizontally) and viewpoint (vertically). The frame grid input 502 is processed through the two parallel pathways by decomposing the frame grid input 502 into a set of freeze-time video inputs 504 (shown as columns of video tokens varying by viewpoint but not time) and a set of fixed-view video inputs 506 (shown as rows of video tokens varying by time but not viewpoint).

The freeze-time video inputs 504 are provided to a freeze-time frozen DiT block 408, while the fixed-view video inputs 506 are provided to a fixed-view frozen DiT block 410. The DiT blocks include pretrained weights from an existing video diffusion model that remain frozen during training. For example, an l-th 4D generation block 414 of the 4D video generation model 302 can include the weights from a corresponding l-th DiT block of a pretrained video diffusion model. The same weights are used in both the freeze-time frozen DiT block 408 and the fixed-view frozen DiT block 410 of the l-th 4D generation block 414. In the freeze-time frozen DiT block 408, the frozen weights are arranged into weight columns 508 for application to columnar freeze-time video tokens of the frame grid input 502. In the fixed-view frozen DiT block 410, the same set of frozen weights are arranged into weight rows 510 for application to row-wise fixed-view video tokens of the frame grid input 502.

Temporal conditioning data 514 and viewpoint conditioning data 516 are generated by processing the input prompts (e.g., fixed-view prompt 418 and freeze-time prompt 420) through context embedding. For the freeze-time pathway, the viewpoint conditioning data 516 encodes viewpoint or camera motion information such as “arc shot”. For the fixed-view pathway, the temporal conditioning data 514 encodes the temporal action such as “a toy truck drives past”.

During training, the conditioning data (e.g., temporal conditioning data 514 and viewpoint conditioning data 516) is used to modulate the synchronization layer 412 by providing additional context about how the temporal and viewpoint variations should be synchronized. The synchronization layer 412 uses this conditioning information to compute either soft or hard synchronization updates between the parallel frozen DiT blocks. For soft synchronization, the conditioning data modulates a linear layer that predicts asymmetrical token updates. For hard synchronization, the conditioning data influences the learned weights used to compute weighted combinations of the pathway outputs.

During inference, the conditioning data continues to guide the synchronization process as the trained 4D video generation model 302 generates new frames, ensuring that temporal changes remain consistent with the fixed viewpoint in one pathway while viewpoint changes maintain temporal consistency in the other pathway. This conditioning helps maintain coherence between the temporal and spatial aspects of the generated 4D video content.

The freeze-time frozen DiT block 408 processes sequences of video frame tokens showing the scene varying in viewpoint, while maintaining a fixed timestamp. The fixed-view frozen DiT block 410 processes sequences showing the scene varying in time, while maintaining a fixed viewpoint.

A synchronization layer 412 connects the parallel DiT blocks to exchange information between their outputs. The synchronization layer 412 receives temporal conditioning data 514 and viewpoint conditioning data 516 to modulate the synchronization process. The synchronized outputs are combined to generate a frame grid output 512 of video frame tokens that maintains consistency across both temporal and viewpoint variations.

In some examples, the synchronization layer 412 implements soft synchronization by computing asymmetrical token updates using a modulated linear layer. The updates are applied separately to the outputs of the DiT blocks to maintain their distribution properties while ensuring coherence. In other examples, the synchronization layer 412 implements hard synchronization by computing weighted combinations of the DiT block outputs using learned weights.

The frame grid output 512 provides spatially and temporally consistent frames to subsequent 4D generation blocks 414 of the 4D video generation model 302, or to the output layer 406. The synchronized parallel processing can enable efficient generation while preserving the high quality of the pretrained video diffusion model.

In some examples, the architecture of the 4D generation blocks 414 shown in FIG. 5 and the overall architecture of the 4D video generation model 302 shown in FIG. 4 enables consistent, efficient generation of 4D video content by providing 2D arrays of video frames of a 4D scene varying in time and viewpoint.

Some existing video diffusion models leverage a transformer-based architecture such as DiT, which forwards video tokens through a series of spatial-temporal transformer blocks with skip connections. Specifically, each DiT transformer block φ₁ produces an update Δx₁ to the current video tokens x₁ at the l-th layer with condition c:

Δx₁=φ₁(x₁;c),x₁+1=x₁+Δx₁

In some examples of the 4D video generation model 302, this principles is extended to a set of tokens describing all frames in the 2D array of time- and viewpoint-varying frames. x₁ denotes the set of all tokens at layer l and x₁,i,j denotes the set of tokens for a frame at layer l with time stamp i and viewpoint j. In order to reuse pre-trained high-quality video diffusion models as much as possible, the 4D video generation model 302 can utilize pre-trained video DiT transformer layers to either update a row for view-point i:

φ^{v}₁({x₁,i,1, . . . ,x₁,i,T};c)for 1≤i≤V
or a column for timestep j of the frame grid:

φ^{t}₁({x₁,1,j, . . . ,x₁,V,j};c)for 1≤j≤T.

Given a total of T timesteps and V viewpoints, the 4D video generation model 302 can process the complete frame grid input 502 received by the input layer 404 by either performing V row updates or T column updates in parallel when reusing existing DiT transformer blocks. The notation y^{v}₁(x₁, c) denotes the update of a single row or a parallel update of all V rows jointly (and the analogous notation denotes a column update y^{v}ₜ(x₁, c)).

In the two-pathway architecture of the 4D video generation model 302, variable (token) splitting is used to create two separate sets of tokens to encode the complete frame grid (e.g., frame grid input 502), x^{v}₁ for temporal updates and x^{t}₁ for view updates. The set x^{v}₁ is processed using T parallel row updates and the set x^{t}₁ is processed using V parallel column updates. Updates are computed independently and in parallel:

y^{v}₁=x^{v}₁+φᵥ(x^{v}₁;cᵥ),y^{t}₁=x^{t}₁+φₜ(x^{t}₁;cₜ),
wherein cᵥ denotes the viewpoint conditioning data 516 and cₜ denotes the temporal conditioning data 514. The freeze-time frozen DiT block 408 shown in the 4D generation block 414 of FIG. 5 generates its outputs as y^{v}₁, and the fixed-view frozen DiT block 410 generates its outputs as y^{t}₁.

The synchronization layer 412 after each DiT block l exchanges information between the two token streams. The synchronization layer 412, denoted f, computes a function (x^{v}₁₊₁, x^{t}₁₊₁)=f(y^{v}₁, y^{t}₁) in order to obtain the input tokens for the next layer (e.g., frame grid output 512).

As noted above, some examples of the synchronization layer 412 use hard synchronization. Hard synchronization strictly enforces the constraint x^{t}₁=x^{v}₁ at every iteration or layer. In some examples, hard synchronization computes an update by averaging tokens. In some examples, hard synchronization can be generalized to compute a weighted combination with learned weights:

x₁₊₁=W^{v}₁y^{v}₁+W^{t}₁y^{t}₁,
wherein W^{v}₁, W^{t}₁ are linear weights for merging each token with initial values: ½ I. The weights can be modulated by a value of the current diffusion timestep σ to make them adaptive to different stages of the diffusion process.

Thus, in some examples, hard synchronization can be implemented as:

Δy₁=Mod_Linear(y^{v}₁,y^{t}₁;σ)

x₁₊₁=½(y^{v}₁+y^{t}₁)+Δy₁

In testing of example implementations, a 4D video generation model 302 using hard synchronization can generate temporally consistent 4D videos, but in some cases may produce less accurate frames when the viewpoint differs significantly from the input fixed-view video 306. Common artifacts include objects appearing stretched in the direction of camera movement or unintended object motion when the time stamp is intended to be frozen. It is hypothesized that hard synchronization may aggregate merged video tokens from both the freeze-time video 308 and the fixed-view video 306, causing a discrepancy in the learned distribution of the pretrained DiT model base.

Also as noted above, some examples of the synchronization layer 412 use soft synchronization. The soft synchronization strategy may address some of the limitations of hard synchronization identified above. In soft synchronization, the video tokens x^{v}₁, x^{t}₁ are kept in the two separate pathways instead of merging them into a single copy as in hard synchronization. Thus, the synchronization layer 412 using soft synchronization may generate two sets of frame grid outputs 512 for each 4D generation block 414. A soft update is used to make the streams more similar. Soft synchronization may provide additional flexibility for the 4D video generation model 302 to adaptively adjust the strength of synchronization at different layers of the 4D video generation model 302. In some examples, a modulated linear layer is used to predict asymmetrical token updates:

(Δy^{v}₁,Δy^{t}₁)=Mod_Linear(y^{v}₁,y^{t}₁;σ)

Then, the tokens are updated separately:

x^{v}₁₊₁=y^{v}₁+Δy^{v}₁

x^{t}₁₊₁=y^{t}₁+Δy^{t}₁

Soft synchronization can provide more flexibility than other approaches, adapting the strength of synchronization across layers. In testing of example implementations, soft synchronization results in better consistency and fewer artifacts in some challenging scenarios, such as large viewpoint changes.

FIG. 6 illustrates a flowchart showing operations of a method 600 for generating 4D video content using parallel freeze-time and fixed-view pathways with synchronized diffusion blocks.

The method 600 begins at operation 602 by obtaining a freeze-time video of a scene. In some examples, this involves receiving a sequence of video frames showing the scene varying in viewpoint while maintaining a fixed timestamp, such as freeze-time video 308. The freeze-time video 308 can be obtained using various techniques, such as the use of text, image, and/or video inputs 102 to a diffusion model 416 to generate the freeze-time video 308.

At operation 604, the system obtains a fixed-view video of the scene. In some examples, this involves receiving a sequence of frames showing temporal changes from a single viewpoint, such as fixed-view video 306. The fixed-view video 306 can be obtained using various techniques, such as the use of text, image, and/or video inputs 102 to a diffusion model 416 to generate the fixed-view video 306.

Operation 606 provides both the freeze-time video 308 and fixed-view video 306 to a 4D video generation model 302. The 4D video generation model 302 processes these inputs through two parallel pathways, wherein each pathway contains frozen diffusion transformer (DiT) blocks arranged to process video tokens having either temporal or viewpoint variations. The DiT blocks comprise pretrained weights from an existing video diffusion model that remain frozen during training. In the examples of FIG. 4 and FIG. 5, the fixed-view pathway includes the series of L fixed-view frozen DiT blocks 410 of the L 4D generation blocks 414, and the freeze-time pathway includes the series of L freeze-time frozen DiT blocks 408 of the L 4D generation blocks 414.

At operation 608, the freeze-time pathway of the 4D video generation model 302 generates multiple freeze-time videos (e.g., the columns of the video frame array 310 output by the 4D video generation model 302) using a first set of DiT blocks (e.g., the series of L freeze-time frozen DiT blocks 408 of the L 4D generation blocks 414). The freeze-time pathway processes a sequence of video frames showing the scene varying in viewpoint while maintaining temporal consistency (e.g., the freeze-time video 308). The freeze-time frozen DiT blocks 408 process columnar sequences of video tokens using weight columns 508 arranged to apply viewpoint updates.

At operation 610, the fixed-view pathway of the 4D video generation model 302 generates multiple fixed-view videos (e.g., the rows of the video frame array 310 output by the 4D video generation model 302) using a second set of DiT blocks (e.g., the series of Z fixed-view frozen DiT blocks 410 of the L 4D generation blocks 414). The fixed-view pathway processes a sequence of video frames showing temporal changes at fixed viewpoints (e.g., fixed-view video 306). The fixed-view frozen DiT blocks 410 process row-wise sequences of video tokens using weight rows 510 arranged to apply temporal updates.

At operation 612, the 4D video generation model 302 synchronizes the freeze-time and fixed-view pathways using synchronization layers 412 interleaved between the serially arranged DiT blocks (408 and 410). The synchronization layers 412 exchange information between the temporal and spatial token pathways to maintain consistency. In some examples, the synchronization layers 412 implement either “hard” synchronization that strictly enforces consistency by averaging token updates, or “soft” synchronization that allows more flexible adaptive updates based on the current diffusion timestep, as described above.

As in existing diffusion models, the outputs of the 4D video generation model 302 can be refined by passing the outputs back through the 4D video generation model 302 as inputs for multiple iterations. Each iteration of the diffusions process can be denoted as a current iteration σ.

The synchronized parallel processing of time- and viewpoint-varying video token data by the two pathways of the 4D video generation model 302 enables efficient generation of spatially and temporally consistent 4D video content while avoiding distributional shifts and artifacts that can occur with some sequential approaches. The described example architecture of the 4D video generation model 302 can leverage pretrained video diffusion models while training only the synchronization layers, thereby potentially reducing training data requirements while maintaining high visual quality and yielding an efficient trained model for inference.

FIG. 7 illustrates a flowchart showing operations of a method 700 for training a 4D video generation model using synchronized parallel pathways for processing video frames varying in viewpoint and time.

At operation 702, the system obtains a 2D array of video frames of a scene varying by viewpoint and time. In some examples, this involves receiving training data comprising video frames arranged in a grid where rows represent fixed-view sequences and columns represent freeze-time sequences, such as video frame array 310.

In some examples, the training method 700 obtains two complementary data sources at operation 702: videos with simulated camera motion through 2D transformations for pre-training, and a (potentially smaller) dataset of true multi-view animated 3D objects used for fine-tuning. This two-source training approach can enable the model to learn both basic temporal-spatial relationships and refined 3D consistency.

Operation 704 applies noise to at least a portion of the 2D array. In some examples, noise is applied to all frames except the first row and first column, which serve as conditional inputs, as shown in FIG. 4. The noise can be applied according to standard diffusion model training approaches, in which random noise is gradually denoised during training.

At operation 706, the system provides the 2D array as input to a 4D video generation model 302. The model includes two parallel pathways with frozen diffusion transformer (DiT) blocks arranged to process either temporal variations (in the fixed-view pathway) or viewpoint variations in the freeze-time pathway). The DiT blocks each include pretrained weights from a corresponding DiT block of an existing video diffusion model. The weights remain frozen during training.

Operation 708 involves operating the freeze-time pathway of the 4D video generation model 302 to de-noise freeze-time videos, which can be propagated through the freeze-time pathway as columns of video tokens. The freeze-time frozen DiT blocks 408 process the columnar sequences of video tokens using weight columns 508 arranged to handle viewpoint variations while maintaining temporal consistency to apply viewpoint updates. In some examples, the freeze-time pathway processes sequences showing the scene varying in viewpoint at fixed timestamps.

Operation 710 involves operating the fixed-view pathway to de-noise fixed-view videos. The fixed-view frozen DiT blocks 410 process row-wise sequences of video tokens using weight rows 510 arranged to handle temporal variations while maintaining viewpoint consistency to apply temporal updates. In some examples, the fixed-view pathway processes sequences showing temporal changes at fixed viewpoints.

At operation 712, the synchronization layers 412 interleaved between the DiT blocks are trained while keeping the DiT block weights frozen. The synchronization layers 412 exchange information between the temporal and spatial token pathways to maintain consistency. In some examples, the synchronization layers 412 implement either “hard” synchronization that strictly enforces consistency by averaging token updates, or “soft” synchronization that allows more flexible adaptive updates based on the current diffusion timestep. The weights of the synchronization layers 412 are tried using machine learning techniques, which can include the calculation and application loss functions.

In some examples, the synchronization layers 412 of the 4D video generation model 302 are trained using a velocity matching loss of rectified flow, which enables training on the two complementary data sources described above. A modulated linear layer computes asymmetrical token updates based on the current diffusion timestep σ. In soft synchronization, the linear layer predicts separate update values for each pathway that are applied independently to maintain the distribution properties of each stream while ensuring coherence. For hard synchronization, the synchronization layer uses learned weights to compute weighted combinations of the pathway outputs, with the weights being modulated by the diffusion time to adapt to different stages of the diffusion process.

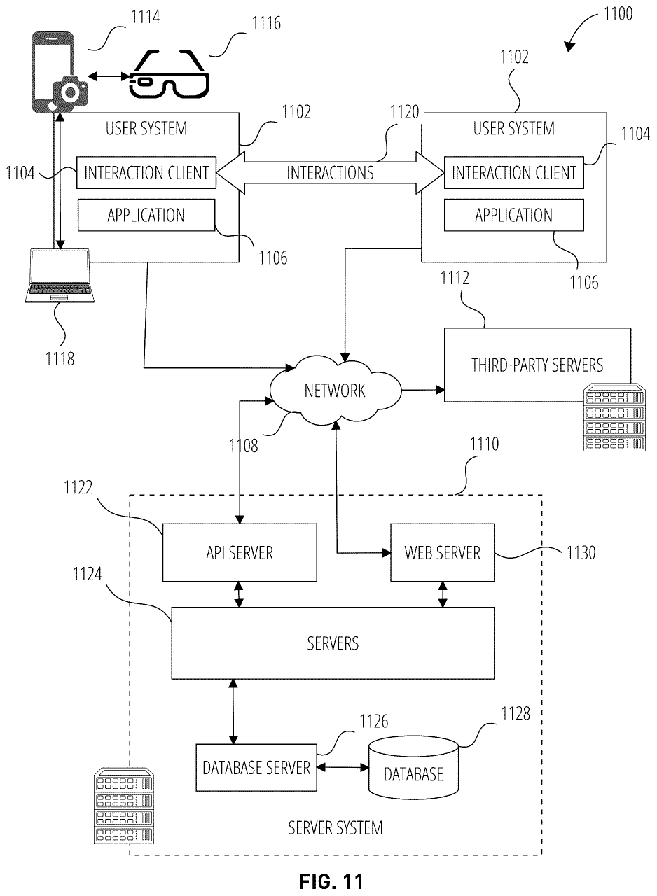

FIG. 8 through FIG. 15, described below, provide examples of hardware and software platforms and environments suitable for implementing the various techniques and systems described above with reference to FIG. 1 through FIG. 7. For example, the XR display systems and devices described with reference to FIG. 8 through FIG. 10 can be used to display interactive 4D video content, and the computing systems and devices described with reference to FIG. 11 through FIG. 15 can be used to perform the methods and/or implement the systems used for training and inference of models and other components used to generate 4D video content.

FIG. 8 is a perspective view of a head-worn XR device (e.g., a display system 800 shown as XR glasses), in accordance with some examples. The display system 800, in this instance, can be worn to view augmented or virtual content displayed over real content visible in a content interaction system.

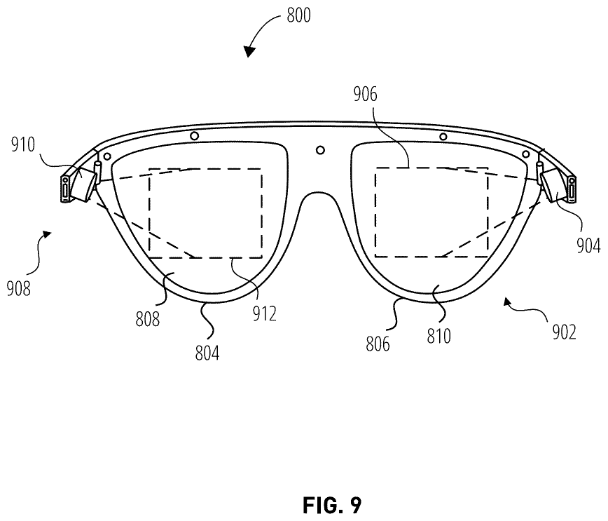

The display system 800 can include a frame 802 made from any suitable material such as plastic or metal, including any suitable shape memory alloy, as is well known for ophthalmic eyewear. In one or more examples, the frame 802 includes a first or left optical element holder 804 (e.g., a display or lens holder) and a second or right optical element holder 806 (e.g., a display or lens holder) connected by a bridge 812. A first or left optical element 808 and a second or right optical element 810 can be provided within respective left optical element holder 804 and right optical element holder 806. The right optical element 810 and the left optical element 808 can be a lens, a display, a display assembly, or a combination of the foregoing. Any suitable display assembly can be provided in the display system 800. The right optical element 810 and the left optical element 808 can each be considered to provide a display configured to present an image at a virtual image surface having a plurality of virtual image surface locations, as described below with reference to FIG. 9.

The frame 802 additionally includes a left arm or temple piece 822 and a right arm or temple piece 824. In some examples the frame 802 can be formed from a single piece of material so as to have a unitary or integral construction.

In some examples, some of the optical elements, such as the projector, waveguide, and other components of the display system 800 are mounted in a separately assembled optical support system. The optical support system includes a monocular chassis that integrates optical components such as the projector, waveguide, and other components into a single sub-assembly. In some examples, the optical support system is provided as a sub-assembly in two versions, left handed and right handed that make up a binocular pair and can be installed into the frame 802, for example into the first or left optical element holder 804 and the second or right optical element holder 806, respectively.

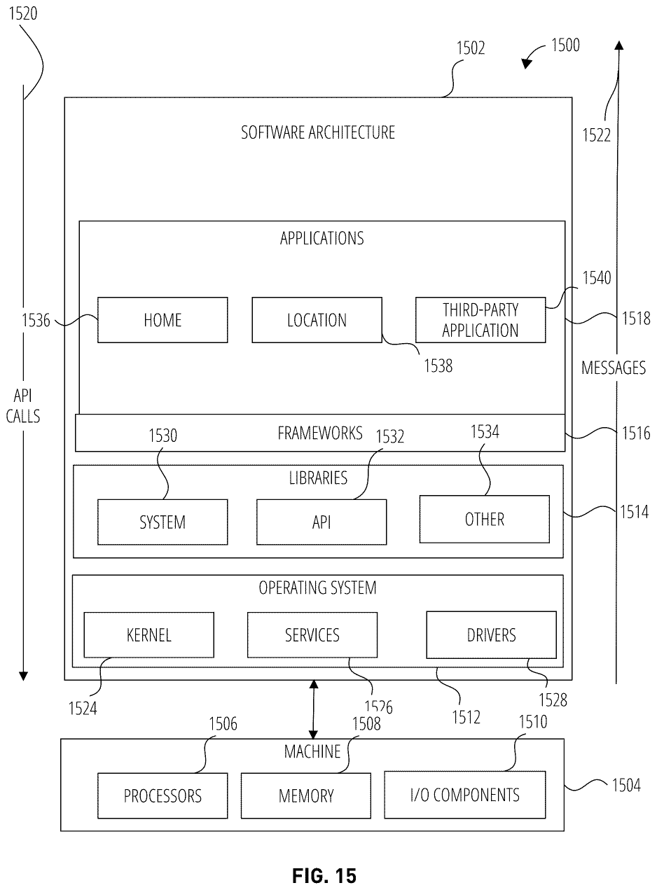

The display system 800 can include a computing device, such as a computer 820 having a processor and a memory storing instructions for execution by the processor. The computer 820 can be of any suitable type so as to be carried by the frame 802 and, in one or more examples, of a suitable size and shape so as to be partially disposed in one of the left temple piece 822 or the right temple piece 824. The computer 820 can include one or more processors with memory, wireless communication circuitry, and a power source. Various other examples may include these elements in different configurations or integrated together in different ways. In some examples, the computer 820 can be implemented by a machine 1400 or machine 1504 as described below with reference to FIG. 14 or FIG. 15.

The computer 820 additionally includes a battery 818 or other suitable portable power supply. In some examples, the battery 818 is disposed in the left temple piece 822 and is electrically coupled to the computer 820 disposed in the right temple piece 824, or vice versa. The display system 800 can include a connector or port (not shown) suitable for charging the battery 818, a wireless receiver, transmitter or transceiver (not shown), or a combination of such devices.

The display system 800 can include a first or left camera 814 and a second or right camera 816. Although two cameras are depicted, other examples contemplate the use of a single or additional (i.e., more than two) cameras. In one or more examples, the display system 800 can include any number of input sensors or other input/output devices in addition to the left camera 814 and the right camera 816, such as location sensors, motion sensors, and so forth. It will be appreciated that the cameras 814, 816 are a form of optical sensor, and that the display system 800 can include additional types of optical sensors in some examples.

FIG. 9 illustrates the display system 800 from the perspective of a user. For clarity, a number of the elements shown in FIG. 8 have been omitted. As described in FIG. 8, the display system 800 shown in FIG. 9 includes left optical element 808 and right optical element 810 secured within the left optical element holder 804 and the right optical element holder 806, respectively.

The display system 800 include right forward optical assembly 902 comprising a right projector 904 and a right display device 906, and a left forward optical assembly 908 including a left projector 910 and a left display device 912. The right forward optical assembly 902 (with or without right optical element 810) may be referred to herein as a right near-eye display, the left forward optical assembly 908 (with or without left optical element 808) may be referred to herein as a left near-eye display, and each may be referred to herein as a near-eye display or a near-eye optical see-through XR display.

In some examples, the right display devices 906 are waveguides. The waveguides include reflective or diffractive structures (e.g., gratings, holograms and/or optical elements such as mirrors, lenses, or prisms). Projected light emitted by the right projector 904 encounters the diffractive structures of the waveguide of the right display device 906, which directs the light towards the right eye of a user to provide an image (e.g., a right-eye image) on or in the right optical element 810 that overlays the view of the real world seen by the user. Similarly, projected light emitted by the left projector 910 encounters the diffractive structures of the waveguide of the left display device 912, which directs the light towards the left eye of a user to provide an image (e.g., a left-eye image) on or in the left optical element 808 that overlays the view of the real world seen by the user. The combination of a graphics processing unit (GPU), the right forward optical assembly 902, the left forward optical assembly 908, the left optical element 808, and the right optical element 810 provide an optical engine of the display system 800. The display system 800 uses the optical engine to generate an overlay of the real world view of the user, including display of a 3D user interface to the user of the display system 800. The surface of the optical element 808 or 810 from which the projected light exits toward the user's eye is referred to as a user-facing surface, an image presentation surface, an eye-side surface, an eye-facing surface, or a display surface of the near-eye optical see-through XR display, whereas the opposite side of the optical element 808 or 810 may be referred to as a world-side surface or world-facing surface. The light exits the image presentation surface of the waveguide at one or more exit pupil locations; at each exit pupil location, the different portions of the image exit at different angles. As a result of the angles at which the light exits the exit pupils toward the user's eye, the image is perceived by a user as extending across a surface in space, referred to herein as a virtual image surface. The virtual image surface is a surface in physical space where the user's eyes converge and focus to view the image; thus, the position and shape of the virtual image surface is a function of the physical properties of the light propagating from the waveguide surface toward the user's eyes.

It will be appreciated that other display technologies or configurations may be utilized within an optical engine to display an image to a user in the user's field of view. For example, instead of a projector 904 and a waveguide, a liquid crystal display (LCD), light emitting diode (LED) array, or other display type may be provided. In some examples, one or more liquid crystal on silicon (LCOS) panels can be used to modulate reflection of light of one or more colors to define individual pixels of the images presented by each display and thereby propagate the colors of light forming the images to various locations across one or more virtual image surfaces. In some examples, one or more LED arrays can be used to emit light of one or more colors from each of an array of LED pixels, thereby propagating the light of one or more colors to various display surface locations. In display types using a conventional 2D screen to present light toward the user's eyes, the virtual image surface can be considered to be identical to the 2D surface of the screen.

In use, a user of the display system 800 will be presented with information, content, and various 3D user interfaces on the near eye displays. The user can then interact with the display system 800 using various input modalities, including the buttons 826, voice inputs or touch inputs on an associated device, and/or hand movements, locations, and positions detected by the display system 800. In some examples, the display system 800 can include additional input devices, such as microphones, touchpads, optical or depth sensors used for gesture recognition, an inertial measurement unit (IMU) used for head motion detection, and so on.

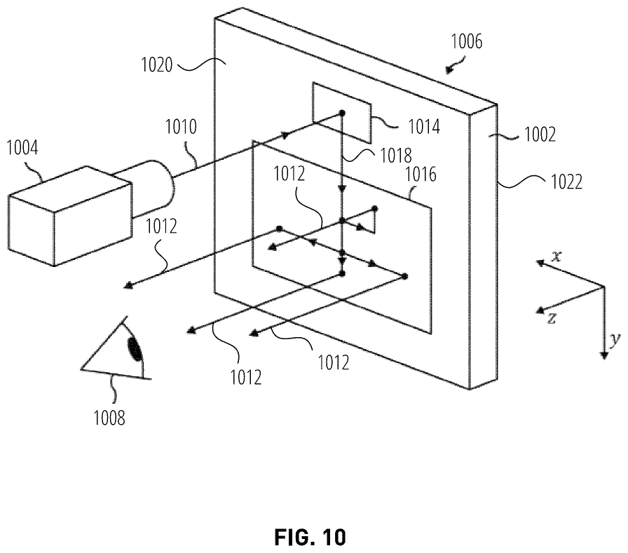

FIG. 10 shows a perspective view of a projector 1004 emitting projected light 1010 (represented in FIG. 10 as a single ray) into a display device 1006. The simplified diagram of FIG. 10 illustrates principles that can be used to implement waveguide-based displays, such as those used by the display system 800.

The display device 1006 includes a waveguide 1002 or light guide. The waveguide 1002 guides light via repeated total internal reflections from opposing surfaces of the waveguide 1002. In the configuration of FIG. 10, the waveguide 1002 can be configured as a planar waveguide or a slab waveguide, such as disposed in the x-y plane. The surfaces can be generally flat or planar surfaces that are parallel to each other and extend in the x-y plane, although in some cases the surface may exhibit curvature. One of the surfaces (e.g., a display surface 1020) can face an eye 1008 of the user. The other of the surfaces (e.g., an opposite surface 1022, also referred to as the world-facing surface) can face away from the eye 1008 of the user.

The waveguide 1002 can include one or more diffractive and/or reflective structures, which can receive the projected light 1010 from the projector 1004, redirect the projected light 1010 internally within the waveguide 1002, and extract the projected light 1010 from the waveguide 1002 to form exiting light 1012. For example, the waveguide 1002 can include one or more diffraction gratings and/or diffraction grating regions, such as a single diffraction grating structure that has individual regions that can function as if they were separate diffraction gratings. The waveguide 1002 can include one or more reflective structures, such as mirrors, prisms, and/or reflective gratings. The waveguide 1002 can include one or more transmissive structures, such as transmissive gratings. The waveguide 1002 can include one or more light-focusing (or collimating-changing) optical elements, such as lenses. Any or all of these structures or elements can be included on one or both surfaces of the waveguide 1002 or in an interior of the waveguide 1002.

In the configuration of FIG. 10, the waveguide 1002 can include an input grating 1014, which can receive the projected light 1010 from the projector 1004 and direct the projected light 1010 into the waveguide 1002 to form light 1018. The waveguide 1002 can include an output grating 1016, which can receive the light 1018, split and redirect the light 1018 internally to extend over a relatively large area (compared to the input grating 1014), and direct the light 1018 out of the waveguide 1002 to form the exiting light 1012. The terms “grating” or “diffraction grating” are used herein to refer to any pattern of diffractive structures or diffractive features. In some examples, the input grating 1014 can be replaced with any component that couples light into the waveguide 1002 such that the light propagates within the waveguide 1002 by total internal reflection. The redirections and splitting can occur from multiple (sequential) interactions with a single diffraction grating, or from sequential interactions with different gratings that are disposed within the surface area of the output grating 1016. For example, a light ray can be diffracted into the waveguide 1002 by the input grating 1014 and be caused to totally internally reflect from one surface of the waveguide 1002 to the other in a direction toward the output grating 1016. The light 1018 can then interact with diffractive features of the output grating 1016 on or within the waveguide 1002. A portion of light 1018 is diffracted laterally within the plane of the waveguide 1002 thereby replicating the image across the area of the output grating 1016, due to multiple interactions with diffractive features that exist across the output grating 1016. Another portion of light 1018 is directed out of the waveguide by diffraction grating 1016 toward the eye 1008 as light 1012. The interactions with the diffractive features of the output grating 1016 can cause internal rays or internal light beams in the waveguide 1002 to change direction within the waveguide 1002. Eventually, the interactions with the diffractive features can cause the internal rays or internal light beams to exit the waveguide 1002 to propagate toward the eye 1008 of the user.

In some examples, the waveguide 1002 can be configured to operate at infinite conjugates. For example, the projector 1004 can project light that forms an image infinitely far away, so that the light would appear in focus on a screen placed relatively far from the projector 1004. Similarly, the output grating 1016 can direct the exiting light 1012 toward the eye in such a manner that the image appears to be infinitely far away to the eye 1008 of the user. For such an infinite-conjugate arrangement, angles in the space of the light that enters and exits the waveguide 1002 can correspond uniquely to image locations in the image. For example, the propagation angles of the light can map uniquely to the propagation angles of the exiting light 1012, which in turn can map uniquely to the image locations in the image at the retina of the eye 1008 of the user.

The waveguide 1002 can make use of this infinite-conjugate relationship to perform so-called “pupil replication” or “pupil expansion”. The projector 1004 can be configured to have an exit pupil that coincides with the input grating 1014. The internal splitting and redirections within the output grating 1016 can effectively expand a surface area of the exit pupil, while maintaining the unique mapping of propagation angle to image location for light in the pupil, and thereby maintaining the unique mapping of virtual image surface location to image location. The size of the output grating 1016 (e.g., an area covered by the replicated pupils, as constrained within a surface area of the output grating 1016) can be larger than a pupil of the eye 1008 of the user, so that if the pupil of the eye 1008 moves, such as caused by the user changing a gaze direction, the amount of light entering the pupil of the eye 1008 may not vary significantly, and the user may not perceive a change in brightness of the image.

### Networked Computing Environment

FIG. 11 is a block diagram showing an example digital interaction system 1100 for facilitating interactions and engagements (e.g., exchanging text messages, conducting text audio and video calls, or playing games) over a network. The digital interaction system 1100 includes multiple user systems 1102, each of which hosts multiple applications, including an interaction client 1104 and other applications 1106. Each interaction client 1104 is communicatively coupled, via one or more networks including a Network 1108 (e.g., the Internet), to other instances of the interaction client 1104 (e.g., hosted on respective other user systems 1102), a server system 1110 and third-party servers 1112). An interaction client 1104 can also communicate with locally hosted applications 1106 using Applications Program Interfaces (APIs).

Each user system 1102 may include multiple user devices, such as a mobile device 1114, head-wearable apparatus 1116 (such as display system 800), and a computer client device 1118 that are communicatively connected to exchange data and messages.

An interaction client 1104 interacts with other interaction clients 1104 and with the server system 1110 via the Network 1108. The data exchanged between the interaction clients 1104 (e.g., interactions 1120) and between the interaction clients 1104 and the server system 1110 includes functions (e.g., commands to invoke functions) and payload data (e.g., text, audio, video, or other multimedia data).

The server system 1110 provides server-side functionality via the Network 1108 to the interaction clients 1104. While certain functions of the digital interaction system 1100 are described herein as being performed by either an interaction client 1104 or by the server system 1110, the location of certain functionality either within the interaction client 1104 or the server system 1110 may be a design choice. For example, it may be technically preferable to initially deploy particular technology and functionality within the server system 1110 but to later migrate this technology and functionality to the interaction client 1104 where a user system 1102 has sufficient processing capacity.

The server system 1110 supports various services and operations that are provided to the interaction clients 1104. Such operations include transmitting data to, receiving data from, and processing data generated by the interaction clients 1104. This data may include message content, client device information, geolocation information, digital effects (e.g., media augmentation and overlays), message content persistence conditions, entity relationship information, and live event information. Data exchanges within the digital interaction system 1100 are invoked and controlled through functions available via user interfaces (UIs) of the interaction clients 1104.

Turning now specifically to the server system 1110, an Application Program Interface (API) server 1122 is coupled to and provides programmatic interfaces to servers 1124, making the functions of the servers 1124 accessible to interaction clients 1104, other applications 1106 and third-party server 1112. The servers 1124 are communicatively coupled to a database server 1126, facilitating access to a database 1128 that stores data associated with interactions processed by the servers 1124. Similarly, a web server 1130 is coupled to the servers 1124 and provides web-based interfaces to the servers 1124. To this end, the web server 1130 processes incoming network requests over the Hypertext Transfer Protocol (HTTP) and several other related protocols.

The Application Program Interface (API) server 1122 receives and transmits interaction data (e.g., commands and message payloads) between the servers 1124 and the user systems 1102 (and, for example, interaction clients 1104 and other application 1106) and the third-party server 1112. Specifically, the Application Program Interface (API) server 1122 provides a set of interfaces (e.g., routines and protocols) that can be called or queried by the interaction client 1104 and other applications 1106 to invoke functionality of the servers 1124. The Application Program Interface (API) server 1122 exposes various functions supported by the servers 1124, including account registration; login functionality; the sending of interaction data, via the servers 1124, from a particular interaction client 1104 to another interaction client 1104; the communication of media files (e.g., images or video) from an interaction client 1104 to the servers 1124; the settings of a collection of media data (e.g., a narrative); the retrieval of a list of friends of a user of a user system 1102; the retrieval of messages and content; the addition and deletion of entities (e.g., friends) to an entity relationship graph; the location of friends within an entity relationship graph; and opening an application event (e.g., relating to the interaction client 1104).

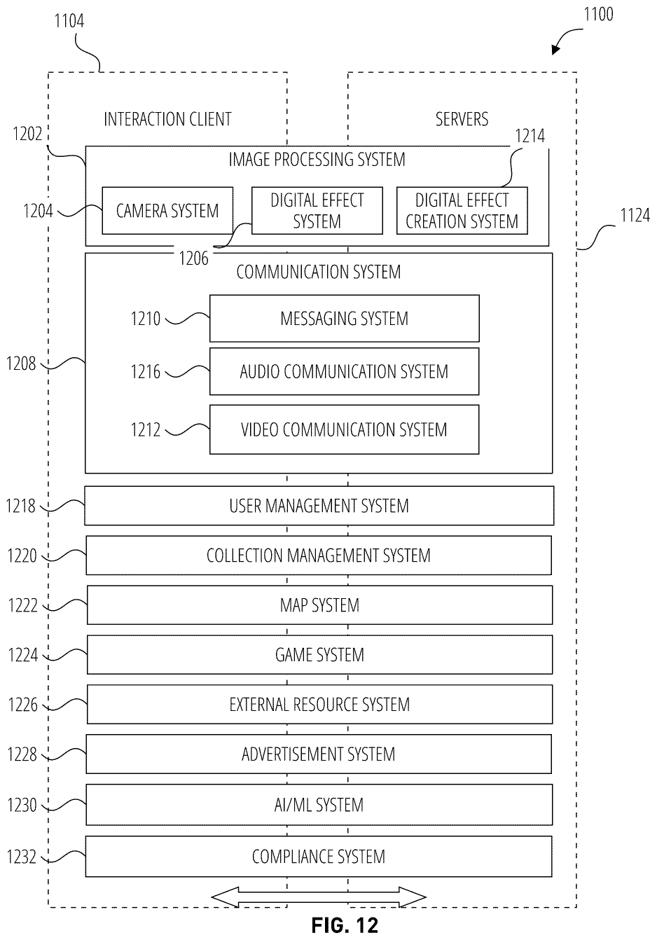

The servers 1124 host multiple systems and subsystems, described below with reference to FIG. 12.

### External Resources and Linked Applications

The interaction client 1104 provides a user interface that allows users to access features and functions of an external resource, such as a linked application 1106, an applet, or a microservice. This external resource may be provided by a third party or by the creator of the interaction client 1104.

The external resource may be a full-scale application installed on the user's system 1102, or a smaller, lightweight version of the application, such as an applet or a microservice, hosted either on the user's system or remotely, such as on third-party servers 1112 or in the cloud. These smaller versions, which include a subset of the full application's features, may be implemented using a markup-language document and may also incorporate a scripting language and a style sheet.

When a user selects an option to launch or access the external resource, the interaction client 1104 determines whether the resource is web-based or a locally installed application. Locally installed applications can be launched independently of the interaction client 1104, while applets and microservices can be launched or accessed via the interaction client 1104.

If the external resource is a locally installed application, the interaction client 1104 instructs the user's system to launch the resource by executing locally stored code. If the resource is web-based, the interaction client 1104 communicates with third-party servers to obtain a markup-language document corresponding to the selected resource, which it then processes to present the resource within its user interface.

The interaction client 1104 can also notify users of activity in one or more external resources. For instance, it can provide notifications relating to the use of an external resource by one or more members of a user group. Users can be invited to join an active external resource or to launch a recently used but currently inactive resource.

The interaction client 1104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 12 is a block diagram illustrating further details regarding the digital interaction system 1100, according to some examples. Specifically, the digital interaction system 1100 is shown to comprise the interaction client 1104 and the servers 1124. The digital interaction system 1100 embodies multiple subsystems, which are supported on the client-side by the interaction client 1104 and on the server-side by the servers 1124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 1100.
Data storage: A microservice subsystem may be responsible for its own data storage, which may be in the form of a database, cache, or other storage mechanism (e.g., using the database server 1126 and database 1128). This enables a microservice subsystem to operate independently of other microservices of the digital interaction system 1100.
Service discovery: Microservice subsystems may find and communicate with other microservice subsystems of the digital interaction system 1100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 1100 may employ a monolithic architecture, a service-oriented architecture (SOA), a function-as-a-service (FaaS) architecture, or a modular architecture:

Example subsystems are discussed below.

An image processing system 1202 provides various functions that enable a user to capture and modify (e.g., augment, annotate or otherwise edit) media content associated with a message.

A camera system 1204 includes control software (e.g., in a camera application) that interacts with and controls hardware camera hardware (e.g., directly or via operating system controls) of the user system 1102 to modify real-time images captured and displayed via the interaction client 1104.

The digital effect system 1206 provides functions related to the generation and publishing of digital effects (e.g., media overlays) for images captured in real-time by cameras of the user system 1102 or retrieved from memory of the user system 1102. For example, the digital effect system 1206 operatively selects, presents, and displays digital effects (e.g., media overlays such as image filters or modifications) to the interaction client 1104 for the modification of real-time images received via the camera system 1204 or stored images retrieved from memory 1302 of a user system 1102. These digital effects are selected by the digital effect system 1206 and presented to a user of an interaction client 1104, based on a number of inputs and data, such as for example:
Geolocation of the user system 1102; and
Entity relationship information of the user of the user system 1102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 1102 for communication in a message, or applied to video content, such as a video content stream or feed transmitted from an interaction client 1104. As such, the image processing system 1202 may interact with, and support, the various subsystems of the communication system 1208, such as the messaging system 1210 and the video communication system 1212.

A media overlay may include text or image data that can be overlaid on top of a photograph taken by the user system 1102 or a video stream produced by the user system 1102. In some examples, the media overlay may be a location overlay (e.g., Venice beach), a name of a live event, or a name of a merchant overlay (e.g., Beach Coffee House). In further examples, the image processing system 1202 uses the geolocation of the user system 1102 to identify a media overlay that includes the name of a merchant at the geolocation of the user system 1102. The media overlay may include other indicia associated with the merchant. The media overlays may be stored in the databases 1128 and accessed through the database server 1126.

The image processing system 1202 provides a user-based publication platform that enables users to select a geolocation on a map and upload content associated with the selected geolocation. The user may also specify circumstances under which a particular media overlay should be offered to other users. The image processing system 1202 generates a media overlay that includes the uploaded content and associates the uploaded content with the selected geolocation.

The digital effect creation system 1214 supports augmented reality developer platforms and includes an application for content creators (e.g., artists and developers) to create and publish digital effects (e.g., augmented reality experiences) of the interaction client 1104. The digital effect creation system 1214 provides a library of built-in features and tools to content creators including, for example custom shaders, tracking technology, and templates.

In some examples, the digital effect creation system 1214 provides a merchant-based publication platform that enables merchants to select a particular digital effect associated with a geolocation via a bidding process. For example, the digital effect creation system 1214 associates a media overlay of the highest bidding merchant with a corresponding geolocation for a predefined amount of time.

In some examples, the digital effect creation system 1214 can include the 4D scene generation system 104, a POV transformation component, and/or a temporal transformation component as described above. The 4D scene generation system 104 can be used to generate a 4D scene model 110 based on inputs received from various components of a digital interaction system 1100, such as text data, image data, pre-existing video data, or video data captured by the camera system 1204. In some examples, the 4D scene generation system 104, a POV transformation component, and/or a temporal transformation component can be implemented by other systems of the image processing system 1202, the digital interaction system 1100, or other components of a computing system.

The POV transformation component and/or temporal transformation component, or components thereof, can be used to generate views of a 4D scene using the generated 4D scene model 110. For example, the transformation component and/or temporal transformation component can use the 4D scene model 110 to dynamically generate views of a scene for use as visual overlays or videos in an XR system as described above. It will be appreciated that the transformation component and/or temporal transformation component can generate a 4D scene model 110, and/or generate interactive or non-interactive content based on a 4D scene model 110, for use by (or using inputs from) one or more other subsystems or components of the systems or devices described herein, such as the game system 1224, the image processing system 1202, the digital effect system 1206, and so on.

A communication system 1208 is responsible for enabling and processing multiple forms of communication and interaction within the digital interaction system 1100 and includes a messaging system 1210, an audio communication system 1216, and a video communication system 1212. The messaging system 1210 is responsible, in some examples, for enforcing the temporary or time-limited access to content by the interaction clients 1104. The messaging system 1210 incorporates multiple timers that, based on duration and display parameters associated with a message or collection of messages (e.g., a narrative), selectively enable access (e.g., for presentation and display) to messages and associated content via the interaction client 1104. The audio communication system 1216 enables and supports audio communications (e.g., real-time audio chat) between multiple interaction clients 1104. Similarly, the video communication system 1212 enables and supports video communications (e.g., real-time video chat) between multiple interaction clients 1104.

A user management system 1218 is operationally responsible for the management of user data and profiles, and maintains entity information regarding users and relationships between users of the digital interaction system 1100.

A collection management system 1220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 1220 may also be responsible for publishing an icon that provides notification of a particular collection to the user interface of the interaction client 1104. The collection management system 1220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 1220 employs machine vision (or image recognition technology) and content rules to curate a content collection automatically. In certain examples, compensation may be paid to a user to include user-generated content into a collection. In such cases, the collection management system 1220 operates to automatically make payments to such users to use their content.

A map system 1222 provides various geographic location (e.g., geolocation) functions and supports the presentation of map-based media content and messages by the interaction client 1104. For example, the map system 1222 enables the display of user icons or avatars on a map to indicate a current or past location of “friends” of a user, as well as media content (e.g., collections of messages including photographs and videos) generated by such friends, within the context of a map. For example, a message posted by a user to the digital interaction system 1100 from a specific geographic location may be displayed within the context of a map at that particular location to “friends” of a specific user on a map interface of the interaction client 1104. A user can furthermore share his or her location and status information (e.g., using an appropriate status avatar) with other users of the digital interaction system 1100 via the interaction client 1104, with this location and status information being similarly displayed within the context of a map interface of the interaction client 1104 to selected users.

A game system 1224 provides various gaming functions within the context of the interaction client 1104. The interaction client 1104 provides a game interface providing a list of available games that can be launched by a user within the context of the interaction client 1104 and played with other users of the digital interaction system 1100. The digital interaction system 1100 further enables a particular user to invite other users to participate in the play of a specific game by issuing invitations to such other users from the interaction client 1104. The interaction client 1104 also supports audio, video, and text messaging (e.g., chats) within the context of gameplay, provides a leaderboard for the games, and supports the provision of in-game rewards (e.g., coins and items).

An external resource system 1226 provides an interface for the interaction client 1104 to communicate with remote servers (e.g., third-party servers 1112) to launch or access external resources, i.e., applications or applets. Each third-party server 1112 hosts, for example, a markup language (e.g., HTML5) based application or a small-scale version of an application (e.g., game, utility, payment, or ride-sharing application). The interaction client 1104 may launch a web-based resource (e.g., application) by accessing the HTML5 file from the third-party servers 1112 associated with the web-based resource. Applications hosted by third-party servers 1112 are programmed in JavaScript leveraging a Software Development Kit (SDK) provided by the servers 1124. The SDK includes Application Programming Interfaces (APIs) with functions that can be called or invoked by the web-based application. The servers 1124 host a JavaScript library that provides a given external resource access to specific user data of the interaction client 1104. HTML5 is an example of technology for programming games, but applications and resources programmed based on other technologies can be used.

To integrate the functions of the SDK into the web-based resource, the SDK is downloaded by the third-party server 1112 from the servers 1124 or is otherwise received by the third-party server 1112. Once downloaded or received, the SDK is included as part of the application code of a web-based external resource. The code of the web-based resource can then call or invoke certain functions of the SDK to integrate features of the interaction client 1104 into the web-based resource.

The SDK stored on the server system 1110 effectively provides the bridge between an external resource (e.g., applications 1106 or applets) and the interaction client 1104. This gives the user a seamless experience of communicating with other users on the interaction client 1104 while also preserving the look and feel of the interaction client 1104. To bridge communications between an external resource and an interaction client 1104, the SDK facilitates communication between third-party servers 1112 and the interaction client 1104. A bridge script running on a user system 1102 establishes two one-way communication channels between an external resource and the interaction client 1104. Messages are sent between the external resource and the interaction client 1104 via these communication channels asynchronously. Each SDK function invocation is sent as a message and callback. Each SDK function is implemented by constructing a unique callback identifier and sending a message with that callback identifier.

By using the SDK, not all information from the interaction client 1104 is shared with third-party servers 1112. The SDK limits which information is shared based on the needs of the external resource. Each third-party server 1112 provides an HTML5 file corresponding to the web-based external resource to servers 1124. The servers 1124 can add a visual representation (such as a box art or other graphic) of the web-based external resource in the interaction client 1104. Once the user selects the visual representation or instructs the interaction client 1104 through a GUI of the interaction client 1104 to access features of the web-based external resource, the interaction client 1104 obtains the HTML5 file and instantiates the resources to access the features of the web-based external resource.

The interaction client 1104 presents a graphical user interface (e.g., a landing page or title screen) for an external resource. During, before, or after presenting the landing page or title screen, the interaction client 1104 determines whether the launched external resource has been previously authorized to access user data of the interaction client 1104. In response to determining that the launched external resource has been previously authorized to access user data of the interaction client 1104, the interaction client 1104 presents another graphical user interface of the external resource that includes functions and features of the external resource. In response to determining that the launched external resource has not been previously authorized to access user data of the interaction client 1104, after a threshold period of time (e.g., 3 seconds) of displaying the landing page or title screen of the external resource, the interaction client 1104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 1104 adds the external resource to a list of authorized external resources and allows the external resource to access user data from the interaction client 1104. The external resource is authorized by the interaction client 1104 to access the user data under an OAuth 2 framework.

The interaction client 1104 controls the type of user data that is shared with external resources based on the type of external resource being authorized. For example, external resources that include full-scale applications (e.g., an application 1106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 1228 operationally enables the purchasing of advertisements by third parties for presentation to end-users via the interaction clients 1104 and handles the delivery and presentation of these advertisements.

An artificial intelligence and machine learning system 1230 provides a variety of services to different subsystems within the digital interaction system 1100. For example, the artificial intelligence and machine learning system 1230 operates with the image processing system 1202 and the camera system 1204 to analyze images and extract information such as objects, text, or faces. This information can then be used by the image processing system 1202 to enhance, filter, or manipulate images. The artificial intelligence and machine learning system 1230 may be used by the digital effect system 1206 to generate modified content and augmented reality experiences, such as adding virtual objects or animations to real-world images. The communication system 1208 and messaging system 1210 may use the artificial intelligence and machine learning system 1230 to analyze communication patterns and provide insights into how users interact with each other and provide intelligent message classification and tagging, such as categorizing messages based on sentiment or topic. The artificial intelligence and machine learning system 1230 may also provide chatbot functionality to message interactions 1120 between user systems 1102 and between a user system 1102 and the server system 1110. The artificial intelligence and machine learning system 1230 may also work with the audio communication system 1216 to provide speech recognition and natural language processing capabilities, allowing users to interact with the digital interaction system 1100 using voice commands. In some examples, the 1230 provides some or all of the model training and/or model inference functionality of the 4D scene generation system 104.

A compliance system 1232 facilitates compliance by the digital interaction system 1100 with data privacy and other regulations, including for example the California Consumer Privacy Act (CCPA), General Data Protection Regulation (GDPR), and Digital Services Act (DSA). The compliance system 1232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 1232 also incorporates opt-in/opt-out management and privacy controls across the digital interaction system 1100, empowering users to manage their data preferences. The compliance system 1232 is designed to handle sensitive data by obtaining explicit consent, implementing strict access controls and in accordance with applicable laws.

System with Head-Wearable Apparatus

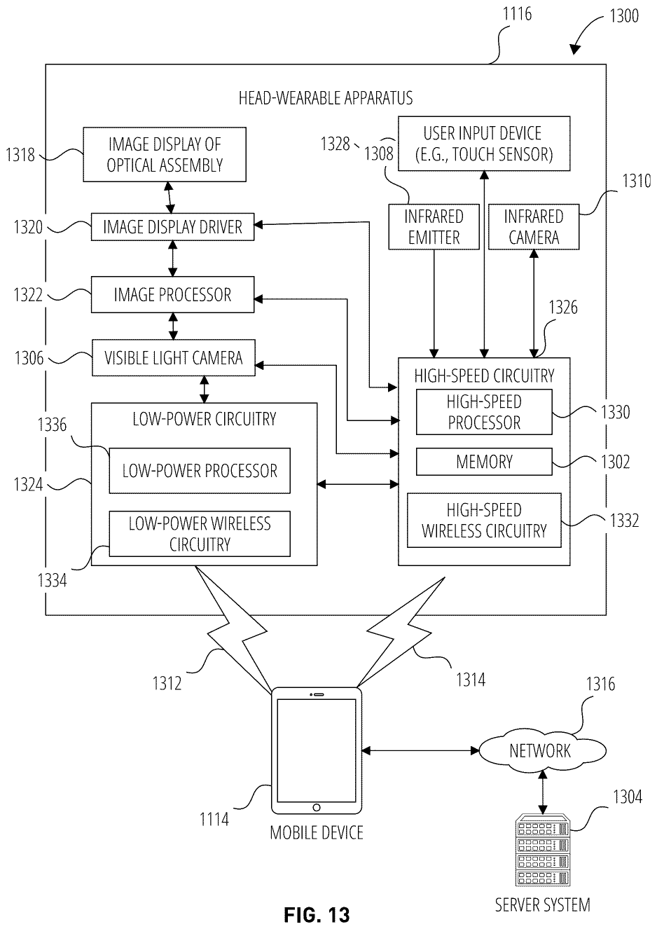

FIG. 13 illustrates a system 1300 including a head-wearable apparatus 1116 with a selector input device, according to some examples. FIG. 13 is a high-level functional block diagram of an example head-wearable apparatus 1116 communicatively coupled to a mobile device 1114 and various server systems 1304 (e.g., the server system 1110) via various Networks 1108.

The head-wearable apparatus 1116 includes one or more cameras, each of which may be, for example, a visible light camera 1306, an infrared emitter 1308, and an infrared camera 1310.

The mobile device 1114 connects with head-wearable apparatus 1116 using both a low-power wireless connection 1312 and a high-speed wireless connection 1314. The mobile device 1114 is also connected to the server system 1304 and the Network 1316.

The head-wearable apparatus 1116 further includes two image displays of the image display of optical assembly 1318. The two image displays of optical assembly 1318 include one associated with the left lateral side and one associated with the right lateral side of the head-wearable apparatus 1116. The head-wearable apparatus 1116 also includes an image display driver 1320, an image Processor 1322, low-power circuitry 1324, and high-speed circuitry 1326. The image display of optical assembly 1318 is for presenting images and videos, including an image that can include a graphical user interface to a user of the head-wearable apparatus 1116.

The image display driver 1320 commands and controls the image display of optical assembly 1318. The image display driver 1320 may deliver image data directly to the image display of optical assembly 1318 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 1116 includes a frame and stems (or temples) extending from a lateral side of the frame. The head-wearable apparatus 1116 further includes a user input device 1328 (e.g., touch sensor or push button), including an input surface on the head-wearable apparatus 1116. The user input device 1328 (e.g., touch sensor or push button) is to receive from the user an input selection to manipulate the graphical user interface of the presented image.

The components shown in FIG. 13 for the head-wearable apparatus 1116 are located on one or more circuit boards, for example a PCB or flexible PCB, in the rims or temples. Alternatively, or additionally, the depicted components can be located in the chunks, frames, hinges, or bridge of the head-wearable apparatus 1116. Left and right visible light cameras 1306 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 1116 includes a memory 1302, which stores instructions to perform a subset, or all the functions described herein. The memory 1302 can also include storage device.

As shown in FIG. 13, the high-speed circuitry 1326 includes a high-speed Processor 1330, a memory 1302, and high-speed wireless circuitry 1332. In some examples, the image display driver 1320 is coupled to the high-speed circuitry 1326 and operated by the high-speed Processor 1330 to drive the left and right image displays of the image display of optical assembly 1318. The high-speed Processor 1330 may be any processor capable of managing high-speed communications and operation of any general computing system needed for the head-wearable apparatus 1116. The high-speed Processor 1330 includes processing resources needed for managing high-speed data transfers on a high-speed wireless connection 1314 to a wireless local area network (WLAN) using the high-speed wireless circuitry 1332. In certain examples, the high-speed Processor 1330 executes an operating system such as a LINUX operating system or other such operating system of the head-wearable apparatus 1116, and the operating system is stored in the memory 1302 for execution. In addition to any other responsibilities, the high-speed Processor 1330 executing a software architecture for the head-wearable apparatus 1116 is used to manage data transfers with high-speed wireless circuitry 1332. In certain examples, the high-speed wireless circuitry 1332 is configured to implement Institute of Electrical and Electronic Engineers (IEEE) 802.11 communication standards, also referred to herein as WI-FI®. In some examples, other high-speed communications standards may be implemented by the high-speed wireless circuitry 1332.

The low-power wireless circuitry 1334 and the high-speed wireless circuitry 1332 of the head-wearable apparatus 1116 can include short-range transceivers (e.g., Bluetooth™, Bluetooth LE, Zigbee, ANT+) and wireless wide, local, or wide area Network transceivers (e.g., cellular or WI-FI®). Mobile device 1114, including the transceivers communicating via the low-power wireless connection 1312 and the high-speed wireless connection 1314, may be implemented using details of the architecture of the head-wearable apparatus 1116, as can other elements of the Network 1316.

The memory 1302 includes any storage device capable of storing various data and applications, including, among other things, camera data generated by the left and right visible light cameras 1306, the infrared camera 1310, and the image Processor 1322, as well as images generated for display by the image display driver 1320 on the image displays of the image display of optical assembly 1318. While the memory 1302 is shown as integrated with high-speed circuitry 1326, in some examples, the memory 1302 may be an independent standalone element of the head-wearable apparatus 1116. In certain such examples, electrical routing lines may provide a connection through a chip that includes the high-speed Processor 1330 from the image Processor 1322 or the low-power Processor 1336 to the memory 1302. In some examples, the high-speed Processor 1330 may manage addressing of the memory 1302 such that the low-power Processor 1336 will boot the high-speed Processor 1330 any time that a read or write operation involving memory 1302 is needed.

As shown in FIG. 13, the low-power Processor 1336 or high-speed Processor 1330 of the head-wearable apparatus 1116 can be coupled to the camera (visible light camera 1306, infrared emitter 1308, or infrared camera 1310), the image display driver 1320, the user input device 1328 (e.g., touch sensor or push button), and the memory 1302.

The head-wearable apparatus 1116 is connected to a host computer. For example, the head-wearable apparatus 1116 is paired with the mobile device 1114 via the high-speed wireless connection 1314 or connected to the server system 1304 via the Network 1316. The server system 1304 may be one or more computing devices as part of a service or network computing system, for example, that includes a processor, a memory, and network communication interface to communicate over the Network 1316 with the mobile device 1114 and the head-wearable apparatus 1116.

The mobile device 1114 includes a processor and a Network communication interface coupled to the processor. The Network communication interface allows for communication over the Network 1316, low-power wireless connection 1312, or high-speed wireless connection 1314. Mobile device 1114 can further store at least portions of the instructions in the memory of the mobile device 1114 memory to implement the functionality described herein.

Output components of the head-wearable apparatus 1116 include visual components, such as a display such as a liquid crystal display (LCD), a plasma display panel (PDP), a light-emitting diode (LED) display, a projector, or a waveguide. The image displays of the optical assembly are driven by the image display driver 1320. The output components of the head-wearable apparatus 1116 further include acoustic components (e.g., speakers), haptic components (e.g., a vibratory motor), other signal generators, and so forth. The input components of the head-wearable apparatus 1116, the mobile device 1114, and server system 1304, such as the user input device 1328, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1116 may also include additional peripheral device elements. Such peripheral device elements may include sensors and display elements integrated with the head-wearable apparatus 1116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1312 and high-speed wireless connection 1314 from the mobile device 1114 via the low-power wireless circuitry 1334 or high-speed wireless circuitry 1332.

### Machine Architecture

FIG. 14 is a diagrammatic representation of a machine 1400 within which instructions 1402 (e.g., software, a program, an application, an applet, an app, or other executable code) for causing the machine 1400 to perform any one or more of the methodologies discussed herein may be executed. For example, the instructions 1402 can cause the machine 1400 to implement and control the display system 800 described above. The instructions 1402 transform the general, non-programmed machine 1400 into a particular machine 1400 programmed to carry out the described and illustrated functions in the manner described. The machine 1400 can operate as a standalone device or can be coupled (e.g., networked) to other machines. In a networked deployment, the machine 1400 can operate in the capacity of a server machine or a client machine in a server-client network environment, or as a peer machine in a peer-to-peer (or distributed) network environment. The machine 1400 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection or system of machines that individually or jointly execute the instructions 1402 to perform any one or more of the methodologies discussed herein. In some examples, the machine 1400 can comprise both client and server systems, with certain operations of a particular method or algorithm being performed on the server-side and with certain operations of the particular method or algorithm being performed on the client-side.

The machine 1400 can include processors 1404, memory 1406, and input/output I/O components 1408, which can be configured to communicate with each other via a bus 1410. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, a processor 1412 and a processor 1414 that execute the instructions 1402. The term “processor” is intended to include multi-core processors that can comprise two or more independent processors (sometimes referred to as “cores”) that can execute instructions contemporaneously. Although FIG. 14 shows multiple processors 1404, the machine 1400 can include a single processor with a single-core, a single processor with multiple cores (e.g., a multi-core processor), multiple processors with a single core, multiple processors with multiples cores, or any combination thereof.

The memory 1406 includes a main memory 1416, a static memory 1418, and a storage unit 1420, all accessible to the processors 1404 via the bus 1410. The main memory 1406, the static memory 1418, and the storage unit 1420 store the instructions 1402 embodying any one or more of the methodologies or functions described herein. The instructions 1402 can also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 can include a wide variety of components to receive input, provide output, produce output, transmit information, exchange information, capture measurements, and so on. The specific I/O components 1408 that are included in a particular machine will depend on the type of machine. For example, portable machines such as mobile phones can include a touch input device or other such input mechanisms, while a headless server machine will likely not include such a touch input device. It will be appreciated that the I/O components 1408 can include many other components that are not shown in FIG. 14. In various examples, the I/O components 1408 can include user output components 1424 and user input components 1426. The user output components 1424 can include or communicate with visual components (e.g., one or more displays such as the left near-eye display and right near-eye display, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1408 can include motion components 1428, environmental components 1430, or position components 1432, among a wide array of other components.

The motion components 1428 include acceleration sensor components (e.g., accelerometer), gravitation sensor components, rotation sensor components (e.g., gyroscope).

The environmental components 1430 include, for example, one or more externally-facing cameras (with still image/photograph and video capabilities) such as left camera 814 and right camera 816, illumination sensor components (e.g., photometer or ambient light sensor), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that can provide indications, measurements, or signals corresponding to a surrounding physical environment.

Further, the camera system of the machine 1400 can include dual rear cameras (e.g., a primary camera as well as a depth-sensing camera), or even triple, quad or penta rear camera configurations on the front and rear sides of the machine 1400. These multiple cameras systems can include a wide camera, an ultra-wide camera, a telephoto camera, a macro camera, and a depth sensor, for example. In some examples, one or more of the cameras can be used as an ambient light sensor.

The position components 1432 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1408 further include communication components 1434 operable to couple the machine 1400 to a network 1436 or devices 1438 via respective coupling or connections. For example, the communication components 1434 can include a network interface component or another suitable device to interface with the network 1436. In further examples, the communication components 1434 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1438 can be another machine or any of a wide variety of peripheral devices (e.g., a peripheral device coupled via a USB).

Moreover, the communication components 1434 can detect identifiers or include components operable to detect identifiers. For example, the communication components 1434 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 1434, such as location via Internet Protocol (IP) geolocation, location via Wi-Fi® signal triangulation, location via detecting an NFC beacon signal that can indicate a particular location, and so forth.

The various memories (e.g., main memory 1416, static memory 1418, and memory of the processors 1404) and storage unit 1420 can store one or more sets of instructions and data structures (e.g., software) embodying or used by any one or more of the methodologies or functions described herein. These instructions (e.g., the instructions 1402), when executed by processors 1404, cause various operations to implement the disclosed examples, including the operation of the display system 800.

The instructions 1402 can be transmitted or received over the network 1436, using a transmission medium, via a network interface device (e.g., a network interface component included in the communication components 1434) and using any one of several well-known transfer protocols (e.g., hypertext transfer protocol (HTTP)). Similarly, the instructions 1402 can be transmitted or received using a transmission medium via a coupling (e.g., a peer-to-peer coupling) to the devices 1438.

### Software Architecture

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. The applications 1518 can include the 4D scene generation system 104, and/or components thereof, as described herein. Operationally, the applications 1518 invoke API calls 1520 through the software stack and receive messages 1522 in response to the API calls 1520. The described examples, and at least some of the functions thereof, can be implemented by components in one or more layers of the software architecture 1502.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematic functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which can be specific to a particular operating system or platform.

In an example, the applications 1518 can include a home application 1536, a location application 1538, and a broad assortment of other applications such as a third-party application 1540. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1540 can invoke the API calls 1520 provided by the operating system 1512 to facilitate functionalities described herein.

### EXAMPLE STATEMENTS

Specific examples are now described.

Example 1 is a system comprising: at least one processor; and a memory storing instructions that, when executed by the at least one processor, cause the system to perform operations comprising: obtaining a freeze-time video comprising a sequence of video frames showing a scene varying in viewpoint; obtaining a fixed-viewpoint video comprising a sequence of video frames showing a scene varying in viewpoint; generating a plurality of generated freeze-time videos of the scene in a freeze-time pathway of a 4D video generation model based on the freeze-time video and the fixed-viewpoint video, the freeze-time pathway comprising a first plurality of diffusion transformer (DiT) blocks of a pretrained DiT video generation model; generating a plurality of generated fixed-viewpoint videos of the scene in a fixed-view pathway of the 4D video generation model based on the freeze-time video and the fixed-viewpoint video, the fixed-view pathway comprising a second plurality of DiT blocks of the pretrained DiT video generation model; and synchronizing the freeze-time pathway and the fixed-view pathway via a plurality of synchronization layers interleaved with the DiT blocks of the freeze-time pathway and the fixed-view pathway.

In Example 2, the subject matter of Example 1 includes, wherein: the 4D video generation model comprises: a series of 4D generation blocks, each 4D generation block comprising: a first diffusion transformer (DiT) block of the first plurality of DiT blocks, comprising a first plurality of weights arranged to process sequences of video frames showing a scene varying in time; a second DiT block of the first plurality of DiT blocks, comprising the first plurality of weights arranged to process sequences of video frames showing the scene varying in viewpoint; and a synchronization layer of the plurality of synchronization layers, trained to process outputs of the first DiT block and the second DiT block to generate a synchronized output to be processed by a next 4D generation block in the series or an output layer of the 4D video generation model, the synchronized output comprising a plurality of video frames showing the scene varying in time and viewpoint.

In Example 3, the subject matter of Example 2 includes, wherein: the first plurality of weights of each 4D generation block comprising frozen weights of a corresponding DiT block of the pretrained DiT video generation model.

In Example 4, the subject matter of Example 3 includes, wherein: the 4D video generation model is trained by training the synchronization layers while maintaining the frozen weights of the DiT blocks.

In Example 5, the subject matter of Examples 1-4 includes, wherein: the plurality of synchronization layers comprise at least one soft synchronization layer to: generate asymmetrical token updates for the freeze-time pathway and the fixed-view pathway using a modulated linear layer; and apply the asymmetrical token updates separately to outputs of the DiT blocks in the freeze-time pathway and the fixed-view pathway.

In Example 6, the subject matter of Examples 1-5 includes, wherein: the plurality of synchronization layers comprise at least one hard synchronization layer to: compute weighted combinations of outputs from the DiT blocks in the freeze-time pathway and the fixed-view pathway using learned weights; and generate synchronized outputs by applying the weighted combinations.

In Example 7, the subject matter of Examples 1-6 includes, wherein the operations further comprise: generating an extended sequence of video frames by: processing the freeze-time video and fixed-view video in a sliding window fashion; and autoregressively generating additional video frames that vary further in at least one of time or viewpoint.

In Example 8, the subject matter of Examples 1-7 includes, wherein: the 4D video generation model is trained using: a first dataset comprising videos with simulated camera motion through 2D transformations; and a second dataset comprising multi-view animated 3D object videos.

In Example 9, the subject matter of Examples 1-8 includes, wherein: at least one of the freeze-time video or the fixed-viewpoint video is obtained using a diffusion model trained to generate videos based on an input.

In Example 10, the subject matter of Example 9 includes, wherein: the input comprises text; and the diffusion model comprises a text-to-video diffusion model.

In Example 11, the subject matter of Examples 9-10 includes, wherein: the input comprises an image; and the diffusion model comprises an image-to-video diffusion model.

In Example 12, the subject matter of Examples 1-11 includes, wherein: the generated plurality of generated fixed-viewpoint videos and the generated plurality of generated freeze-time videos jointly form an array of video frames varying in time along a first axis and varying by viewpoint along a second axis.

In Example 13, the subject matter of Example 12 includes, wherein: the operations further comprise upsampling the video frames of the array of video frames using a diffusion-based upsampler to increase resolution.

In Example 14, the subject matter of Examples 12-13 includes, wherein: the operations further comprise reconstructing a 3D representation of the scene from the array of video frames.

In Example 15, the subject matter of Example 14 includes, wherein: the 3D representation comprises a 3D Gaussian splat representation.

In Example 16, the subject matter of Examples 14-15 includes, wherein: the generating of the one or more views of the scene comprises: receiving pose data from an XR device; generating a point of view transformation based on the pose data; applying the point of view transformation to the 3D representation to generate at least one view of the scene from at least one viewpoint corresponding to the pose data; and displaying the at least one view on the XR device in real-time.

In Example 17, the subject matter of Example 16 includes, wherein: the at least one view of the scene is a photorealistic view.

In Example 18, the subject matter of Examples 16-17 includes, wherein: the at least one view of the scene is a view of an action occurring over time.

Example 19 is a method comprising: obtaining a freeze-time video comprising a sequence of video frames showing a scene varying in viewpoint; obtaining a fixed-viewpoint video comprising a sequence of video frames showing a scene varying in viewpoint; generating a plurality of generated freeze-time videos of the scene in a freeze-time pathway of a 4D video generation model based on the freeze-time video and the fixed-viewpoint video, the freeze-time pathway comprising a first plurality of diffusion transformer (DiT) blocks of a pretrained DiT video generation model; generating a plurality of generated fixed-viewpoint videos of the scene in a fixed-view pathway of the 4D video generation model based on the freeze-time video and the fixed-viewpoint video, the fixed-view pathway comprising a second plurality of DiT blocks of the pretrained DiT video generation model; and synchronizing the freeze-time pathway and the fixed-view pathway via a plurality of synchronization layers interleaved with the DiT blocks of the freeze-time pathway and the fixed-view pathway.

Example 20 is a non-transitory computer-readable storage medium, the computer-readable storage medium including instructions that, when executed by at least one processor of a system, cause the system to implement a four-dimensional (4D) video generation model comprising: a series of 4D generation blocks, each 4D generation block comprising: a first diffusion transformer (DiT) block of a pretrained DiT video generation model comprising a first plurality of weights arranged to process sequences of video frames showing a scene varying in time; a second DiT block of the pretrained DiT video generation model comprising the first plurality of weights arranged to process sequences of video frames showing the scene varying in viewpoint; and a synchronization layer trained to process outputs of the first DiT block and the second DiT block to generate a synchronized output to be processed by a next 4D generation block in the series or an output layer of the 4D video generation model, the synchronized output comprising a plurality of video frames showing the scene varying in time and viewpoint.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the figures, descriptions, and claims herein.

### TERM EXAMPLES

“2D” refers to, for example, a two-dimensional space, object, or representation, such as an image or a surface.

“3D” refers to, for example, a three-dimensional space, object, or representation, such as a three-dimensional volumetric model or a representation of a scene.

“4D” refers to, for example, a 3D space, object, or representation that changes or moves over time, or that includes a representation of changes of a 3D space or object over time.

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hard ware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Extended reality” (XR) refers, for example, to an interactive experience of a real-world environment where physical objects that reside in the real-world are “augmented” or enhanced by computer-generated digital content (also referred to as virtual content or synthetic content). XR can also refer to a system that enables a combination of real and virtual worlds, real-time interaction, and 3D registration of virtual and real objects. A user of an XR system perceives virtual content that appears to be attached to, or interacts with, a real-world physical object. XR includes augmented reality (AR) and virtual reality (VR).

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” refers, for example, to a tangible medium that is capable of storing, encoding, or carrying the instructions for execution by a machine.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

### CONCLUSION

Described examples of 4D video generation systems seek to provide technical solutions to one or more example technical problems.

First, some existing methods for generating 4D video content suffer from slow processing speeds and computational inefficiency. Previous score distillation sampling approaches require hours to generate a single result. The described examples can address this by implementing a novel two-stream architecture with parallel processing pathways and synchronized diffusion blocks, enabling generation of an 8×8 frame grid in approximately 1-2 minutes rather than hours.

Second, existing approaches can struggle with maintaining both temporal and spatial consistency across generated video frames. The described examples can solve this through a synchronized two-pathway architecture wherein one stream handles temporal updates along rows sharing the same viewpoint while the other stream processes spatial updates along columns sharing the same timestamp. A synchronization layer coordinates between the streams to maintain consistency across both dimensions.

Third, existing approaches face challenges in generalizing beyond limited training datasets while maintaining photorealistic quality. The described technology addresses this through a hybrid training approach combining two complementary data sources: (1) regular videos with simulated camera motion through 2D transformations to learn basic temporal-spatial relationships, and (2) true multi-view animated 3D objects to refine 3D consistency understanding. This enables the system to generate high-quality outputs even with limited 4D training data.

Fourth, existing approaches that sequentially interleave temporal and view updates often produce artifacts and reduced generalization due to distributional shifts between processing stages. The described examples can solve this through soft synchronization layers that adaptively modulate information exchange between parallel pathways based on the current diffusion timestep, avoiding accumulation of artifacts while preserving the learned distribution of the pretrained video model.

Fifth, existing approaches struggle to efficiently generate extended sequences beyond fixed grid sizes. The described examples can enable flexible sequence generation through autoregressive processing in a sliding window fashion, allowing generation of arbitrary-length sequences while maintaining consistency.

Sixth, existing approaches often require explicit camera pose inputs, which limits usability. The described examples can eliminate this requirement by taking a freeze-time video and fixed-view video as conditional inputs, automatically inferring the viewpoints and motion to be generated. This simplifies the process of animating existing freeze-time videos by removing the need for manual camera pose specification.

Seventh, existing approaches can face challenges in real-time rendering for XR applications. The described examples can address this by enabling efficient construction of 3D Gaussian splat representations from the generated frame grid, allowing real-time novel view synthesis based on XR device pose data.

Eighth, existing approaches often produce flattened or distorted results when generating novel viewpoints. The described examples can solve this through the combination of parallel processing pathways and synchronized diffusion blocks that maintain 3D consistency, along with training on true multi-view data to learn proper depth relationships.

Ninth, existing approaches frequently require complex optimization procedures that limit practical applications. The described examples implement a feed-forward architecture that generates results directly through a single forward pass, enabling practical deployment in real-world scenarios.

Tenth, existing approaches struggle to leverage existing high-quality video generation models while extending to 4D. The described examples address this by freezing pretrained diffusion transformer blocks and only training lightweight synchronization layers, preserving the quality of existing models while enabling 4D generation.

Other technical problems may be addressed by various examples described herein, as will be appreciated by a skilled person.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

What is claimed is:

1. A system comprising:
at least one processor; and
a memory storing instructions that, when executed by the at least one processor, cause the system to perform operations comprising:
obtaining a freeze-time video comprising a sequence of video frames showing a scene varying in viewpoint;
obtaining a fixed-viewpoint video comprising a sequence of video frames showing a scene varying in time;
generating a plurality of generated freeze-time videos of the scene in a freeze-time pathway of a 4D video generation model based on the freeze-time video and the fixed-viewpoint video, the freeze-time pathway comprising a first plurality of diffusion transformer (DiT) blocks of a pretrained DiT video generation model;
generating a plurality of generated fixed-viewpoint videos of the scene in a fixed-view pathway of the 4D video generation model based on the freeze-time video and the fixed-viewpoint video, the fixed-view pathway comprising a second plurality of DiT blocks of the pretrained DiT video generation model; and
synchronizing the freeze-time pathway and the fixed-view pathway via a plurality of synchronization layers interleaved with the DiT blocks of the freeze-time pathway and the fixed-view pathway.

2. The system of claim 1, wherein:
the 4D video generation model comprises:
a series of 4D generation blocks, each 4D generation block comprising:
a first DiT block of the first plurality of DiT blocks, comprising a first plurality of weights arranged to process sequences of video frames showing a scene varying in time;
a second DiT block of the first plurality of DiT blocks, comprising the first plurality of weights arranged to process sequences of video frames showing the scene varying in viewpoint; and
a synchronization layer of the plurality of synchronization layers, trained to process outputs of the first DiT block and the second DiT block to generate a synchronized output to be processed by a next 4D generation block in the series or an output layer of the 4D video generation model, the synchronized output comprising a plurality of video frames showing the scene varying in time and viewpoint.

3. The system of claim 2, wherein:
the first plurality of weights of each 4D generation block comprising frozen weights of a corresponding DiT block of the pretrained DiT video generation model.

4. The system of claim 3, wherein:
the 4D video generation model is trained by training the synchronization layers while maintaining the frozen weights of the DiT blocks.

5. The system of claim 1, wherein:
the plurality of synchronization layers comprise at least one soft synchronization layer to:
generate asymmetrical token updates for the freeze-time pathway and the fixed-view pathway using a modulated linear layer; and
apply the asymmetrical token updates separately to outputs of the DiT blocks in the freeze-time pathway and the fixed-view pathway.

6. The system of claim 1, wherein:
the plurality of synchronization layers comprise at least one hard synchronization layer to:
compute weighted combinations of outputs from the DiT blocks in the freeze-time pathway and the fixed-view pathway using learned weights; and
generate synchronized outputs by applying the weighted combinations.

7. The system of claim 1, wherein the operations further comprise:
generating an extended sequence of video frames by:
processing the freeze-time video and fixed-view video in a sliding window fashion; and
autoregressively generating additional video frames that vary further in at least one of time or viewpoint.

8. The system of claim 1, wherein:
the 4D video generation model is trained using:
a first dataset comprising videos with simulated camera motion through 2D transformations; and
a second dataset comprising multi-view animated 3D object videos.

9. The system of claim 1, wherein:
at least one of the freeze-time video or the fixed-viewpoint video is obtained using a diffusion model trained to generate videos based on an input.

10. The system of claim 9, wherein:
the input comprises text; and
the diffusion model comprises a text-to-video diffusion model.

11. The system of claim 9, wherein:
the input comprises an image; and
the diffusion model comprises an image-to-video diffusion model.

12. The system of claim 1, wherein:
the generated plurality of generated fixed-viewpoint videos and the generated plurality of generated freeze-time videos jointly form an array of video frames varying in time along a first axis and varying by viewpoint along a second axis.

13. The system of claim 12, wherein:
the operations further comprise upsampling the video frames of the array of video frames using a diffusion-based upsampler to increase resolution.

14. The system of claim 12, wherein:
the operations further comprise reconstructing a 3D representation of the scene from the array of video frames.

15. The system of claim 14, wherein:
the 3D representation comprises a 3D Gaussian splat representation.

16. The system of claim 14, further comprising:
receiving pose data from an XR device;
generating a point of view transformation based on the pose data;
applying the point of view transformation to the 3D representation to generate at least one view of the scene from at least one viewpoint corresponding to the pose data; and
displaying the at least one view on the XR device in real-time.

17. The system of claim 16, wherein:
the at least one view of the scene is a photorealistic view.

18. The system of claim 16, wherein:
the at least one view of the scene is a view of an action occurring over time.

19. A method comprising:
obtaining a freeze-time video comprising a sequence of video frames showing a scene varying in viewpoint;
obtaining a fixed-viewpoint video comprising a sequence of video frames showing a scene varying in time;
generating a plurality of generated freeze-time videos of the scene in a freeze-time pathway of a 4D video generation model based on the freeze-time video and the fixed-viewpoint video, the freeze-time pathway comprising a first plurality of diffusion transformer (DiT) blocks of a pretrained DiT video generation model;
generating a plurality of generated fixed-viewpoint videos of the scene in a fixed-view pathway of the 4D video generation model based on the freeze-time video and the fixed-viewpoint video, the fixed-view pathway comprising a second plurality of DiT blocks of the pretrained DiT video generation model; and
synchronizing the freeze-time pathway and the fixed-view pathway via a plurality of synchronization layers interleaved with the DiT blocks of the freeze-time pathway and the fixed-view pathway.

20. A non-transitory computer-readable storage medium, the computer-readable storage medium including instructions that, when executed by at least one processor of a system, cause the system to implement a four-dimensional (4D) video generation model comprising:
a series of 4D generation blocks, each 4D generation block comprising:
a first diffusion transformer (DiT) block of a pretrained DiT video generation model comprising a first plurality of weights arranged to process sequences of video frames showing a scene varying in time;
a second DiT block of the pretrained DiT video generation model comprising the first plurality of weights arranged to process sequences of video frames showing the scene varying in viewpoint; and
a synchronization layer trained to process outputs of the first DiT block and the second DiT block to generate a synchronized output to be processed by a next 4D generation block in the series or an output layer of the 4D video generation model, the synchronized output comprising a plurality of video frames showing the scene varying in time and viewpoint.
